(19) United States
(12) Patent Application Publication
(10) Pub. No.: US 2026/0356064 A1
(43) Pub. Date: Nov. 12, 2026

(54) METHOD FOR MANUFACTURING AT LEAST ONE PORTION OF A FOOTWEAR, FOR EXAMPLE A SHOE, A SANDAL, A BOOT, ETC., AND IN PARTICULAR A FOOTWEAR FOR PRACTICING A SPORT

(71) Applicant: DECATHLON, VILLENEUVE D'ASCQ (FR)

(72) Inventors: Murielle GUILLOT, Wambrechies (FR); Stéphane BENADDI, Wasquehal (FR); Antoine CULLIER, TAICHUNG CITY (TW); Michele RAMINA, Templeuve (FR)

(21) Appl. No.: 19/120,912

(22) PCT Filed: Oct. 2, 2023
(86) PCT No.: PCT/FR2023/051523

§ 371 Date: Apr. 14, 2025

(30) Foreign Application Priority Data
Oct. 12, 2022 (FR) FR2210476

(51) Int. Cl. B29D 35/06; B29D 35/08

(52) U.S. Cl. CPC B29D 35/061; B29D 35/081

(57) ABSTRACT

A method for manufacturing at least one portion of a footwear including the following steps: providing a mold defining an open cavity, a shape of at least one portion of the cavity corresponding to a shape of a sole of the footwear, the cavity being configured to receive, via at least one injection channel opening into the cavity, a mixture comprising a molten material and a supercritical fluid; placing a rim of an opening of the open cavity in contact with a docking area of a surface of at least one portion of a shaft of the footwear, so that the surface of the at least one portion of the shaft ensures closure of the cavity at the level of the contact between the docking area and the rim; pressurizing the cavity; injecting the mixture in the cavity; depressurizing the cavity of the mold, to trigger an expansion of the mixture in the cavity and form the sole in a foamed material resulting from the expansion of the mixture, the at least one portion of the surface of the at least one portion of the shaft being embedded in said foamed material of the sole.

### CROSS REFERENCE TO RELATED APPLICATIONS

This application is a National Stage of PCT Application No. PCT/FR2023/051523 filed on Oct. 2, 2023, which claims priority to French Patent Application No. 22/10476 filed on Oct. 12, 2022 and French Patent Application No. 23/03432 filed on Apr. 6, 2023, the contents each of which are incorporated herein by reference thereto.

### TECHNICAL FIELD

The present disclosure relates to the field of manufacture of footwears, for example shoes, and in particular the manufacture of footwears comprising a light and damping sole, and in particular footwears for practicing a sport.

### BACKGROUND

It is known to manufacture a sole in a first step and then link the sole to a shaft, in particular made at least partially of textile, in a second step. The manufacture of footwears whose sole is light and damping requires many steps because the sole is made separately, most often of crosslinked ethylene-vinyl acetate (EVA), and then assembled by gluing to the shaft.

The drawback of this known method is that it requires many energy-intensive manual gluing operations.

Besides, two methods for direct injection over the shaft are already known:
injection of a thermoplastic, PVC or other elastomers. With this method, the material may be foamed thanks to a chemical or physical foaming agent; however the drawback of this method is that the material of the sole of the obtained shoe does not have the expected properties of a light and damping sole. The lowest sole density that could be reached with this method is greater than 0.5 g/cm3.

In addition, the damping and comfort properties desired for the soles of running shoes for example cannot be reached with this manufacturing method.
direct injection of polyurethane over the shaft. In this case, foaming is obtained by chemical reaction of 2 compounds (Polyol and Isocyanate). The drawback of this method is that the density of the sole remains high (>0.35 g/cm3 in the best case).

Moreover, the non-thermoplastic nature of polyurethane makes recyclability extremely difficult.

### BRIEF SUMMARY

Hence, the present disclosure aims to provide a solution to all or part of these problems.

To this end, the present disclosure relates to a method for manufacturing at least one portion of a footwear, for example a shoe, and in particular a footwear for practicing a sport, comprising the following steps:
providing a mold defining an open cavity, a shape of at least one portion of the cavity corresponding to a shape of a sole of the footwear, the cavity being configured to receive, via at least one injection channel opening into the cavity, a mixture comprising a molten material and a supercritical fluid;
placing a rim of an opening of the open cavity in contact with a docking area of a surface of at least one portion of a shaft of the footwear, so that the surface of the at least one portion of the shaft ensures closure of the cavity at the level of the contact between the docking area and the rim;
pressurizing the cavity;
injecting the mixture in the cavity;
depressurizing the cavity of the mold, to trigger an expansion of the mixture in the cavity and form the sole in a foamed material resulting from the expansion of the mixture, the at least one portion of the surface of the at least one portion of the shaft being embedded in the foamed material of the sole.

According to these arrangements, the method may obtain, in one single injection step, a light and damping sole of the footwear linked to a portion of a shaft of the footwear, with a good delamination resistance of the sole and of the shaft.

According to one implementation, the dimensions of the shape of the at least one portion of the cavity have dimensions at a scale comprised between 1:0.98 and 1:1.02, advantageously 1:1, of the shape of the sole of the footwear.

According to one implementation, the pressurization of the cavity is accompanied with the simultaneous creation of a counter-pressure, advantageously with a substantially identical value, in an area of the at least one portion of the shaft on the other side of the closure with respect to the cavity.

According to these arrangements, the counter-pressure, advantageously with a substantially identical value, allows avoiding leakages, at the level of the contact between the docking area and the rim, of a pressurization gas of the cavity.

Advantageously, the area of the at least one portion of the shaft on the other side of the closure with respect to the cavity may be depressurized simultaneously with the depressurization of the cavity of the mold to trigger an expansion of the mixture in the cavity and form the sole during the progress of the method according to the present disclosure.

According to these arrangements, a pressure of pressurization in the cavity followed by a depressurization in the cavity enables an expansion of the mixture and obtaining the light and damping foamed material of the sole.

According to these arrangements, the density of the sole is comprised between 0.1 g/cm3 and 0.4 g/cm3, preferably between 0.15 g/cm3 and 0.25 g/cm3.

According to one implementation, the present disclosure comprises one or more of the following features, considered separately or according to any technically-feasible combination.

According to one implementation, a pressurization pressure of the cavity is comprised between 3 bars and 50 bars, preferably between 10 bars and 30 bars, preferably equal to 15 bars.

According to one implementation, the method further comprises, prior to the step of pressurizing the cavity, the following step:
placing a cap over the mold so as to form with the mold a closed volume comprising the cavity, and a complementary portion of the cavity in the closed volume, the at least one portion of the shaft being located inside the closed volume, the complementary portion and the cavity being located on either side of the closure of the cavity at the level of the contact between the docking area and the rim.

A pressurization pressure in the complementary portion of the closed volume, advantageously identical to the pressurization pressure of the cavity, allows creating the counter-pressure in order to avoid leakages, at the level of the contact between the docking area and the rim, of a pressurization gas of the cavity.

According to one implementation, the cap is configured to form with the mold a sealed closed volume, in particular gastight, around the at least one portion of the shaft, so as to enable the creation of the counter-pressure inside this sealed closed volume, in particular by receiving the pressurization gas of the cavity in this sealed volume, in order to avoid leakages, at the level of the contact between the docking area and the rim, of a pressurization gas of the cavity.

According to one implementation, the method comprises a step of assembling the portion of the shaft linked to the sole, with another portion of the shaft, the assembly forming the footwear.

According to one implementation, the assembly step comprises knitting the other portion of the shaft with the portion of the shaft linked to the sole.

According to one implementation, the method further comprises the following steps, implemented before the step of placing the rim of the opening of the open cavity in contact with the docking area of a surface of the at least one portion of a shaft:
providing a support having a shape corresponding to a shape of a foot,
covering, at least partially, an outer surface of the support with the at least one portion of the shaft of the footwear, the at least one portion of the surface of the at least one portion of the shaft covering a portion of the outer surface of the support corresponding to a sole of the foot,
so that after placing the cap over the mold, the closed volume further comprises the support with the at least one portion of the shaft.

According to one implementation, the at least one portion of the shaft is a complete shaft.

According to one implementation, the support is made of aluminum, of steel, or of plastic.

According to these arrangements, the method allows obtaining, in one single injection step and with one single mold, a complete footwear comprising the sole of the footwear linked to the complete shaft of the shoe.

According to one implementation, the mold is made in one-piece.

According to one implementation, the mold comprises at least two portions and the provision step comprises a step of assembling the at least two portions to form the mold.

According to one implementation, the mold comprises a ring-like portion comprising a first ring half and a second ring half, the first half being movable relative to the second ring half according to a sliding direction, so that a sliding displacement of the first half towards the second half according to the sliding direction closes the ring-like portion of the mold, whereas a sliding displacement of the first half and of the second half in an opposite way opens the ring-like portion of the mold while separating the two halves of the ring-like portion.

According to one implementation, the mold further comprises a mold bottom comprising a cover and a bell, the bell being configured to wrap the cover, and the first ring half and the second ring half of the mold when the ring-like portion and the mold are closed.

According to one implementation, the bell of the mold bottom comprises a contact interface between the bell of the mold bottom and the ring-like portion, the contact interface comprising a first inclined plane configured to slip over a first contact surface of a wall of the first ring half, the contact interface comprising a second inclined plane configured to slip over a second contact surface of a wall of the second ring half, the first angle of inclination of the first inclined plane and the second angle of inclination of the second inclined plane being configured so that the step of assembling and closing the mold comprises a displacement of the bell of the bottom of the mold towards the two halves in the direction of approaching the two halves of the ring-like portion, so as to close the ring-like portion on contact of the mold bottom.

According to one implementation, the mold comprises an elastic device configured to separate the first ring half and the second ring half.

According to one implementation, the contact interface between the bell of the mold bottom and the ring-like portion comprises at least one guide configured to accompany the sliding displacement of the two portions of the ring when the bell of the mold bottom is displaced in the direction transverse to the sliding direction.

According to these arrangements, the mold is alternately actuated in closure, respectively in opening, through a displacement of the mold bottom towards the two halves of the ring-like portion, respectively in the opposite way.

According to one implementation, the cavity is configured to receive the mixture via at least two injection channels opening into the cavity.

According to these arrangements, the method allows obtaining even more quickly, and with a more homogeneous filling of the cavity of the mold, a sole of the footwear linked to a portion of the shaft of the footwear.

According to one implementation, the mold comprises the at least one injection channel.

According to one implementation, the support comprises the at least one injection channel.

According to one implementation, the method comprises a step of gluing the at least one portion of the surface of the at least one portion of the shaft, the gluing step being carried out before the injection step.

According to one implementation, the at least one portion of the surface of the at least one portion of the shaft comprises hot-melt wires configured to melt down at an injection temperature of the mixture.

According to these arrangements, the delamination resistance of the sole and of the shaft is enhanced.

According to one implementation, the method further comprises the following steps:
providing inserts configured to be positioned in the cavity of the mold;
positioning the inserts in the cavity of the mold.

According to one implementation, the inserts are positioned so as to be inserted at the level of an outer surface of the sole, or to be buried inside the sole.

According to these arrangements, the delamination resistance of the sole is reinforced, or a dynamism of the sole is improved, respectively depending on whether the inserts are inserted towards an outer portion of the sole, with for example one or more inserts made of rubber or of a thermoplastic material, or buried inside the sole, for example with one or more inserts made of carbon board or of a thermoplastic material.

According to one implementation, a contact surface between an insert and the sole comprises a texture.

According to one implementation, the texture comprises a plurality of patterns distributed over a portion of the contact surface according to a density depending on a mechanical load of the portion of the contact surface.

According to one implementation, the density is determined, so that over a portion of the contact surface, the plurality of patterns occupies part of the portion of the contact surface, the portion being comprised between 1% and 15%, advantageously 6%, of the portion of the contact surface.

According to one implementation, the patterns are tubular and/or linear.

According to one implementation, a height of the patterns according to a direction transverse to the contact surface is comprised between 1 mm and 10 mm, preferably equal to 1.6 mm.

According to one implementation, a thickness of the patterns, according to a direction transverse to the direction of the height, is comprised between 1 mm and 2 mm, preferably equal to 1.6 mm.

According to these arrangements, the adhesion between the insert and the sole is enhanced, by mechanical hooking, thereby getting rid of the gluing or surface preparation steps.

According to one implementation, an insert is positioned so as to be inserted at the level of an outer surface of the sole comprises at least one through hole, the at least one through hole being matched with a pressurization channel, so that a pressurization gas could pass through the insert.

According to one implementation, the at least one portion of the surface of the at least one portion of the shaft is at least partially punctured or open.

According to these arrangements, the delamination resistance of the sole and of the shaft is enhanced.

According to one implementation, the at least one portion of the surface of the at least one portion of the shaft is textured or apertured on contact with the docking area.

According to these arrangements, the delamination resistance of the sole and of the shaft is further enhanced.

According to these arrangements, a delamination resistance higher than 2.5 N/mm, measured according to the standard ISO NF EN 1392, is obtained.

According to one implementation, the molten material is an elastomer thermoplastic polymer.

According to one implementation, the thermoplastic polymer is a thermoplastic polyurethane (TPU), or an ether-amide block copolymer (PEBA), or an ethylene-vinyl acetate (EVA), or a polyolefin, or an ether-ester block copolymer, or a styrene-based elastomer, or a mixture of these different components.

According to one implementation, the supercritical fluid is nitrogen in a supercritical state or a carbonic gas in a supercritical state or a mixture of nitrogen and carbonic gas in a supercritical state.

According to one implementation:
most of the mass of the shaft being made of a shaft main material, and possibly of one or several shaft auxiliary material(s);
most of the mass of the sole being made of a sole main material, and possibly of one or several sole auxiliary material(s), the foamed material, resulting from the expansion of the mixture, comprising the sole main material and the sole auxiliary material(s);
the shaft main material, and possibly the shaft auxiliary material(s), is/are selected from among the following materials: polyolefins, styrenic thermoplastic elastomers, olefinic thermoplastic elastomers, vulcanized thermoplastic elastomers, thermoplastic polyurethanes (TPU), polyamides, an ether-amide block copolymer (PEBA), an ethylene-vinyl acetate (EVA), an ether-ester block copolymer, a styrene-based elastomer, and a polyester, and in that the sole main material, and possibly the sole auxiliary material(s), is/are of the same chemical family as the shaft main material, and possibly is/are of the same chemical family as the shaft auxiliary material(s), or in that the sole main material, and possibly the sole auxiliary material(s) is/are chemically compatible with the shaft main material, and possibly with the shaft auxiliary material(s).

Thus, the sole main material may be of the same chemical family as the shaft main material. Thus, for example, if the shaft main material is a polyolefin, the sole main material is also a polyolefin. If the shaft main material is a polyamide, the sole main material is also a polyamide.

In the context of the present disclosure, it should be understood that two polymers are “chemically compatible” when, in the microscopic level, they form a homogeneous medium and no distinct phase is observed.

Thus, a light, damping and recyclable shoe is obtained, preferably not requiring the application of a glue or a bonding agent between the shaft and the sole.

In one embodiment, the sole main material, and possibly the sole auxiliary material(s) is/are identical to the shaft main material, and possibly is/are identical to the shaft auxiliary material(s).

Since the shaft main material, and possibly the shaft auxiliary material(s), and the sole main material, and possibly the sole auxiliary material(s), is/are selected from among the same materials, or are chemically compatible with each other, their adhesion is facilitated, as well as the manufacture of the footwear and also recycling thereof. Indeed, it is not necessary to separate all of the components of the footwear to recycle it. Recycling may be performed in one single step by shredding the footwear and then by forming granules from the shreds. The Applicant has surprisingly found that the sole and shaft main materials listed hereinabove have the advantage that they could be in the very different forms in a footwear application and could be recycled several times.

Advantageously, the shaft and sole main, and possibly auxiliary, materials are selected so that the granules, at least partially recycled, are able to be transformed by any plastics shaping technique (in particular at hot temperature), for example by injection molding, by injection foaming, by extrusion molding, by blowing extrusion, by thermoforming or else by thermo-molding. The granules derived from the recycled footwear according to the present disclosure may be used in the manufacture of a sole or of a shoe component (such as a rear buttress, a front hard tip, or a lateral reinforcement) or else in the manufacture of a wire (for example by extrusion-spinning) for the manufacture of a textile component (for example the manufacture of a shaft component or of the entirety of the shaft by knitting or weaving) or of a component made of foam. The granules derived from the footwear may also be used in the manufacture of a boot.

The granules may also be transformed into a mattress, for example by a so-called Meltblown or Spunbond technique or by a combination thereof, such as a so-called SMS (Spunbond/Meltblown/Spunbond) mattress for example.

The shaft main material may be selected from among polyesters, thermoplastic polyurethanes (TPU), polyolefins, and block copolymers composed of rigid polyamide blocks and of flexible polyether blocks.

The sole main material may be selected from among polyesters, thermoplastic polyurethanes (TPU), polyolefins, and block copolymers composed of rigid polyamide blocks and of flexible polyether blocks.

The shaft may comprise a wire comprising a material selected from among: polyolefins, styrenic thermoplastic elastomers, olefinic thermoplastic elastomers, vulcanized thermoplastic elastomers, a thermoplastic polyurethane (TPU), an ether-amide block copolymer (PEBA), an ethylene-vinyl acetate (EVA), an ether-ester block copolymer, a styrene-based elastomer, and a polyester.

The shaft may comprise a textile component, and in that the textile component comprises a wire comprising the shaft main material.

The shaft may comprise a textile portion forming an area for receiving the foot having an outer face, and at least one part, in particular one strip, comprising an olefinic thermoplastic elastomer, the strip being secured to the outer face of the textile portion and to the sole.

The sole may comprise a cellular component, and/or beads made of foam, comprising a material selected from among: polyolefins, styrenic thermoplastic elastomers, olefinic thermoplastic elastomers, a thermoplastic polyurethane (TPU), an ether-amide block copolymer (PEBA), an ethylene-vinyl acetate (EVA), an ether-ester block copolymer, a styrene-based elastomer, and a polyester.

The shaft may comprise a front hard tip comprising the shaft main material or a shaft auxiliary material, and/or a rear buttress comprising the shaft main material or a shaft auxiliary material.

The shaft may comprise at least one loop for the passage of at least one lacing element, the at least one passage loop comprises a textile strip comprising at least one wire comprising the shaft main material, in particular the shaft main material is a polyolefin.

The shaft may comprise a component made of foam comprising the shaft main material, in particular the shaft main material is a polyolefin.

In one embodiment, the shaft and/or the sole comprises/each comprises, a material recycled from a sole and/or the shaft of another shoe, and/or a material recycled from a sole and/or the shaft of a boot.

Advantageously, the ratio of the mass of the shaft main material, and possibly of the mass of the shaft auxiliary material(s), to the total mass of the shaft is greater than or equal to 40%.

Advantageously, the ratio of the mass of the shaft main material and of the mass of the shaft auxiliary material(s), to the total mass of the shaft is greater than or equal to 50%.

Advantageously, the ratio of the mass of the sole main material, and possibly of the mass of the sole auxiliary material(s), to the total mass of the sole is greater than or equal to 40%.

Advantageously, the ratio of the mass of the sole main material and of the mass of the sole auxiliary material(s), to the total mass of the sole is greater than or equal to 50%.

The footwear may comprise at most 10 weight % of one or several contaminant material(s) that is/are not selected from among polyolefins, styrenic thermoplastic elastomers, olefinic thermoplastic elastomers, vulcanized thermoplastic elastomers, thermoplastic polyurethanes (TPU), polyamides, an ether-amide block copolymer (PEBA), an ethylene-vinyl acetate (EVA), an ether-ester block copolymer, a styrene-based elastomer, and a polyester, in particular at most 10 weight % of one or several thermoplastic contaminant material(s) and/or at most 5 weight % of one or several thermosetting contaminant material(s).

Advantageously, the sole main material, and possibly the sole auxiliary material(s), is/are derived at least in part from recycling of at least one other footwear.

The method may further comprise the collection of the footwear, and it may comprise the transformation of the footwear into thermoplastic granules.

Advantageously, the transformation step comprises:
a step of shredding the at least one shoe to obtain shred particles;
a step of compacting the shred particles to obtain shred and compacted particles, in particular cold or hot compaction,
a step of extruding-granulating the shred and compacted particles to obtain granules that can be transformed by a plastic hot transformation process.

The method may comprise a step of hot transforming at least part of the thermoplastic granules for the manufacture of a plastic part, in particular partially forming an item for practicing a sport.

The present disclosure also relates to plastic part, in particular forming at least partially an item for practicing a sport, which could be obtained by this method, in particular the part is a swimming flipper.

According to one aspect, the present disclosure also relates to a footwear, for example a shoe, and in particular a footwear for practicing a sport, obtained by the method according to one of the previously-described implementations.

The shaft and sole main materials, and possibly the shaft and/or sole auxiliary material(s), selected in the present disclosure may be thermoplastic materials that have the advantage of being derived from olefins. Thus, these materials may advantageously be transformed several times at hot temperature without their properties being considerably degraded, in particular because of the oxidation caused by air and/or humidity. This ability enables them to improve the longevity of their recyclability cycle in contrast with some polymer materials, such as polyurethanes in particular, which oxidize over time. Advantageously, the footwear may thus be recycled several times.

The shaft auxiliary material(s) may be different from the shaft main material and/or from the sole main material.

The shaft auxiliary material(s) may be different from each other.

The sole auxiliary material(s) may be different from the sole main material and/or from the shaft main material.

The sole auxiliary material(s) may be different from each other.

By “the shaft main or auxiliary material is identical to the sole main or auxiliary material”, it should be understood that the shaft main/auxiliary material is in the same base polymer material as that of the sole main/auxiliary material.

The same reasoning applies between two shaft or sole auxiliary materials that would be identical or different.

By “the main or auxiliary shaft material is different from the sole main or auxiliary material”, it should be understood that the shaft main/auxiliary material is not in the same base polymer material as that of the sole main/auxiliary material.

Preferably, the shaft main material and/or the sole main material is/are selected from among polyolefins, and/or olefinic thermoplastic elastomers, and/or styrenic thermoplastic elastomers, and/or vulcanized thermoplastic elastomers.

In one embodiment, the shaft main material is a thermoplastic polyurethane (TPU), or an ether-amide block copolymer (PEBA), or an ethylene-vinyl acetate (EVA), or a polyolefin, or an ether-ester block copolymer, or a styrenic thermoplastic elastomer, or an olefinic thermoplastic elastomer, or a vulcanized thermoplastic elastomer, or a styrene-based elastomer, or a polyester, or a mixture of these different components.

In one embodiment, the sole main material is a thermoplastic polyurethane (TPU), or an ether-amide block copolymer (PEBA), or an ethylene-vinyl acetate (EVA), or a polyolefin, or an ether-ester block copolymer, or a styrenic thermoplastic elastomer, or an olefinic thermoplastic elastomer, or a vulcanized thermoplastic elastomer, or a styrene-based elastomer, or a polyester, or a mixture of these different components.

Preferably, a vulcanized thermoplastic elastomer is used only in an outsole and not in an intermediate sole. Thus, in one embodiment, only the outsole is the only portion of the sole that could comprise a thermoplastic vulcanizate (TPV).

Preferably, the shaft auxiliary material(s) is/are selected from among polyolefins and/or styrenic thermoplastic elastomers and/or olefinic thermoplastic elastomers and/or vulcanized thermoplastic elastomers.

Preferably, the sole auxiliary material(s) is/are selected from among polyolefins and/or styrenic thermoplastic elastomers and/or olefinic thermoplastic elastomers and/or vulcanized thermoplastic elastomers.

### Shaft

Preferably, the shaft comprises a forefoot region configured to cover all or part of the forefoot, and a hindfoot region configured to cover all or part of the hindfoot, and/or a medial region configured to cover all or part of the medial side of the foot, and/or a lateral region configured to cover all or part of a lateral side of the foot, and/or an insole region configured to cover all or part of the insole, and/or a leg region configured to cover all or part of the leg.

Advantageously, the shaft comprises (possibly is constituted of) the shaft main material, and possibly one or several shaft auxiliary material(s), in particular the shaft auxiliary material(s) is/are different from the shaft main material and possibly different from each other.

For example, the shaft main material may be a thermoplastic polyurethane (TPU), or an ether-amide block copolymer (PEBA), or an ethylene-vinyl acetate (EVA), or a polyolefin, or an ether-ester block copolymer, or a styrenic thermoplastic elastomer, or an olefinic thermoplastic elastomer, or a vulcanized thermoplastic elastomer, or a styrene-based elastomer, or a polyester, or a mixture of these different components, and a first shaft auxiliary material may be an olefinic thermoplastic elastomer or a vulcanized thermoplastic elastomer.

For example, the shaft main material may be polypropylene or polyethylene, and the shaft comprises a first shaft auxiliary material, different from the shaft main material, selected from among polypropylene and polyethylene. Thus, the shaft main material may be polypropylene and the first shaft auxiliary material may be polyethylene.

In one embodiment, the footwear is a shoe, and the shaft main material is a thermoplastic polyurethane (TPU), or an ether-amide block copolymer (PEBA), or an ethylene-vinyl acetate (EVA), or a polyolefin, or an ether-ester block copolymer, or a styrenic thermoplastic elastomer, or an olefinic thermoplastic elastomer, or a vulcanized thermoplastic elastomer, or a styrene-based elastomer, or a polyester, or a mixture of these different components, and preferably a polyolefin, preferably polypropylene or polyethylene.

In one embodiment, the shaft main material is different from the sole main material, and the sole also comprises a first sole auxiliary material identical to the shaft main material (in particular the sole auxiliary material is not predominant in the mass of the sole). Preferably, the shaft main material is a polyolefin, the sole main material is a styrenic thermoplastic elastomer, and the first sole auxiliary material is a polyolefin.

The shaft main material and/or the sole main material and/or the shaft auxiliary material(s) and/or the sole auxiliary material(s) may be one or more material(s) recycled from a sole and/or the shaft of another shoe or of a boot and/or plastic and/or be derived from the biomass.

The shaft may comprise (in particular may be constituted of) one or several shaft component(s) comprising (in particular constituted of) the shaft main material and/or one or several shaft auxiliary material(s).

The shaft component may be a textile component, or a reinforcing component, or a component for lacing, or a damping component, or a cellular component such as a foam, or a lace, or a loop, or a front hard tip, or a rear or lateral buttress, or a combination thereof.

The textile component may be a tissue, a knitting, a mattress, a braid, a cable, a fiber-spun wire, a multi-filament wire, a single-filament wire, a set of fibers, or a combination thereof.

The textile component may be a three-dimensional textile (a knitting or a fabric for example), i.e. comprising upper and lower textile panels linked by intermediate wires extending between the textile panels.

The textile component may be a knitted component, for example knitted on a rectilinear knitting machine, or on a warp knitting machine, or on a warp or weft circular knitting machine, in particular a small-diameter one.

The textile component may be a knitted tube, in particular a knitted sock comprising a knitted sole portion;

Preferably, the shaft comprises one or several shaft component(s) assembled by gluing, knitting, or by welding (for example by ultrasounds or by high-frequencies).

Preferably, the shaft comprises a textile component with a one-piece textile construction, in particular with a one-piece knitted or woven construction, the component comprising a forefoot region and/or a hindfoot region and/or a lateral region and/or a medial region and/or an instep region.

By “one-piece textile construction”, it should be understood the textile component does not comprises knit(s) or weld(s) other than those that might be necessary for shaping thereof, for example to join edges.

In one embodiment, the shaft comprises a cellular component, in particular a foam, and/or beads made of foam, comprising a material selected from among polyolefins, styrenic thermoplastic elastomers, olefinic thermoplastic elastomers, vulcanized thermoplastic elastomers, thermoplastic polyurethanes (TPU), polyamides, an ether-amide block copolymer (PEBA), an ethylene-vinyl acetate (EVA), an ether-ester block copolymer, a styrene-based elastomer, and a polyester, preferably an olefinic thermoplastic elastomer or a polyolefin, still preferably a polyolefin. The material may be the shaft main material or a shaft auxiliary material.

Preferably, the shaft comprises a cellular component, in particular a foam, and/or beads made of foam, comprising the shaft main material.

In one embodiment, the mass fraction of the shaft main material in the shaft is greater than or equal to 20%, preferably greater than or equal to 30%, still preferably greater than or equal to 40%.

Preferably, the mass fraction of the shaft main material in the shaft is less than or equal to 90%, in particular less than or equal to 80%, more particularly less than or equal to 70%, in particular less than or equal to 60%.

Alternatively, the mass fraction of the shaft main material in the shaft may be greater than or equal to 60%, preferably greater than or equal to 70%, still preferably greater than or equal to 80%, preferably greater than or equal to 90%.

In one embodiment, the surface fraction occupied by the shaft main material in the shaft is greater than or equal to 30%, preferably greater than or equal to 40%, still preferably greater than or equal to 50%.

Preferably, the surface fraction occupied by the shaft main material in the shaft is less than or equal to 90%, in particular less than or equal to 80%, more particularly less than or equal to 70%.

Alternatively, the surface fraction occupied by the shaft main material in the shaft may be greater than or equal to 60%, preferably greater than or equal to 80%, still preferably greater than or equal to 90%.

Preferably, the surface fraction occupied by the shaft main material and by one or several shaft auxiliary material(s) in the shaft is greater than or equal to 60%, still preferably greater than or equal to 70%, preferably greater than or equal to 80%.

In one embodiment, the shaft comprises the shaft main material and a first shaft auxiliary material, the mass fraction of the first shaft auxiliary material in the shaft is greater than or equal to 5%, preferably greater than or equal to 20%.

The mass fraction of the first shaft auxiliary material in the shaft is preferably less than or equal to 60%, preferably less than or equal to 50%, still preferably less than or equal to 40%.

In one embodiment, the shaft comprises the shaft main material and one or several shaft auxiliary material(s), in particular first and/or second shaft auxiliary material(s); the ratio of the mass of the shaft main material, and of the mass of the shaft auxiliary material(s), to the total mass of the shaft is greater than or equal to 50%, preferably greater than or equal to 60%, still preferably greater than or equal to 70%, preferably greater than or equal to 80%, in particular greater than or equal to 90%.

Optionally, the ratio of the mass of the shaft main material, and of the mass of the shaft auxiliary material(s), to the total mass of the shaft is less than or equal to 90% or 80%.

Advantageously, the shaft comprises a first shaft auxiliary material which is selected from among polyolefins, styrenic thermoplastic elastomers, olefinic thermoplastic elastomers, vulcanized thermoplastic elastomers, thermoplastic polyurethanes (TPU), polyamides, an ether-amide block copolymer (PEBA), an ethylene-vinyl acetate (EVA), an ether-ester block copolymer, a styrene-based elastomer, and a polyester; preferably a polyolefin or an olefinic thermoplastic elastomer or a vulcanized thermoplastic elastomer; still preferably a polyolefin.

Advantageously, the shaft comprises a first shaft auxiliary material and a second shaft auxiliary material which is selected from among polyolefins, styrenic thermoplastic elastomers, olefinic thermoplastic elastomers, vulcanized thermoplastic elastomers, thermoplastic polyurethanes (TPU), polyamides, an ether-amide block copolymer (PEBA), an ethylene-vinyl acetate (EVA), an ether-ester block copolymer, a styrene-based elastomer, and a polyester; preferably a polyolefin or an olefinic thermoplastic elastomer or a vulcanized thermoplastic elastomer; still preferably a polyolefin.

Preferably, the first shaft auxiliary material is different from the second shaft auxiliary material.

In one embodiment, the footwear is a shoe, and the shaft main material is selected from among polyolefins, styrenic thermoplastic elastomers, olefinic thermoplastic elastomers, vulcanized thermoplastic elastomers, thermoplastic polyurethanes (TPU), polyamides, an ether-amide block copolymer (PEBA), an ethylene-vinyl acetate (EVA), an ether-ester block copolymer, a styrene-based elastomer, and a polyester.

Preferably, the mass fraction of the shaft main material in the shaft is greater than or equal to 40% and less than or equal to 80%, still preferably less than or equal to 60%.

Preferably, the mass fraction of the first shaft auxiliary material in the shaft is greater than or equal to 5%, still preferably less than or equal to 40%, still preferably less than or equal to 30%; for example comprised between 25% and 40%.

Preferably, the surface fraction of the shaft main material which is a polyolefin, in particular polypropylene, in the shaft, is greater than or equal to 45%. Still preferably, the surface fraction of the shaft main material and of a first shaft auxiliary material which is a polyolefin, in particular polyethylene, in the shaft, is greater than or equal to 70%. In particular the surface fraction of a second shaft auxiliary material, which is an olefinic thermoplastic elastomer or a styrenic thermoplastic elastomer or a vulcanized thermoplastic element, in the shaft, is greater than or equal to 15%, in particular less than or equal to 30%.

In one embodiment, the footwear is a shoe, and the shaft main material is an olefinic thermoplastic elastomer or a vulcanized thermoplastic elastomer, optionally the shaft further comprises a first shaft auxiliary material, in particular which is a polyolefin, for example polypropylene or polyethylene.

Preferably, the mass fraction of the shaft main material in the shaft is greater than or equal to 40% and less than or equal to 80%, still preferably less than or equal to 60%.

Preferably, the mass fraction of the first shaft auxiliary material in the shaft is greater than or equal to 5%, still preferably greater than or equal to 20%, in particular greater than or equal to 30% and less than or equal to 50%, more particularly greater than or equal to 35% and less than or equal to 45%.

### Sole

The sole comprises (in particular is constituted of) the sole main material and possibly one or several sole auxiliary material(s), in particular different from the sole main material.

Preferably, the sole auxiliary material(s) is/are selected from among polyolefins, styrenic thermoplastic elastomers, olefinic thermoplastic elastomers, vulcanized thermoplastic elastomers, thermoplastic polyurethanes (TPU), polyamides, an ether-amide block copolymer (PEBA), an ethylene-vinyl acetate (EVA), an ether-ester block copolymer, a styrene-based elastomer, and a polyester.

For example, the sole main material may be a styrenic thermoplastic elastomer and the sole comprises a first sole auxiliary material, which is a polyolefin, for example polypropylene or polyethylene.

Advantageously, the sole comprises a first sole auxiliary material which is selected from among polyolefins, styrenic thermoplastic elastomers, olefinic thermoplastic elastomers, vulcanized thermoplastic elastomers, thermoplastic polyurethanes (TPU), polyamides, an ether-amide block copolymer (PEBA), an ethylene-vinyl acetate (EVA), an ether-ester block copolymer, a styrene-based elastomer, and a polyester; preferably a polyolefin or a styrenic thermoplastic elastomer or a vulcanized thermoplastic elastomer.

Preferably, the mass fraction of the sole main material in the sole is greater than or equal to 25%, still preferably greater than or equal to 40%, preferably greater than or equal to 50%, more preferably greater than or equal to 60%.

Preferably, the mass fraction of the sole main material in the sole is less than or equal to 80%.

Preferably, the mass fraction of the first sole auxiliary material, in the sole, is greater than or equal to 10%, still preferably less than or equal to 40%, preferably less than or equal to 30%, for example comprised between 15% and 25% (upper and lower bounds included).

In one embodiment, the sole comprises the sole main material, and possibly one or several sole auxiliary material(s), in particular first and/or second sole auxiliary material(s), the ratio of the mass of the sole main material, and possibly of the mass of the sole auxiliary material(s), to the total mass of the sole is greater tan or equal to 30%, preferably greater than or equal to 40%, still preferably greater than or equal to 50%, preferably greater than or equal to 60%, still preferably greater than or equal to 70%, preferably greater than or equal to 80%, in particular greater than or equal to 90%.

Optionally, the ratio of the mass of the sole main material, and possibly of the mass of the sole auxiliary material(s), to the total mass of the sole is less than or equal to 90%, in particular less than or equal to 80%, more particularly less than or equal to 70%.

In one embodiment, the footwear is a shoe, and the sole main material is selected from among polyolefins, styrenic thermoplastic elastomers, olefinic thermoplastic elastomers, vulcanized thermoplastic elastomers, thermoplastic polyurethanes (TPU), polyamides, an ether-amide block copolymer (PEBA), an ethylene-vinyl acetate (EVA), an ether-ester block copolymer, a styrene-based elastomer, and a polyester.

Preferably, the mass fraction of the sole main material is greater than or equal to 55% and less than or equal to 70%.

Preferably, the mass fraction of the first sole auxiliary material is greater than or equal to 5% and less than or equal to 35%, in particular greater than or equal to 10% and less than or equal to 30%.

In one embodiment, the sole main material is selected from among polyolefins, styrenic thermoplastic elastomers, olefinic thermoplastic elastomers, vulcanized thermoplastic elastomers, thermoplastic polyurethanes (TPU), polyamides, an ether-amide block copolymer (PEBA), an ethylene-vinyl acetate (EVA), an ether-ester block copolymer, a styrene-based elastomer, and a polyester; preferably a styrenic thermoplastic elastomer, preferably SEBS or SBS, and the sole comprises a first sole auxiliary material selected from among polyolefins, styrenic thermoplastic elastomers, olefinic thermoplastic elastomers, vulcanized thermoplastic elastomers, thermoplastic polyurethanes (TPU), polyamides, an ether-amide block copolymer (PEBA), an ethylene-vinyl acetate (EVA), an ether-ester block copolymer, a styrene-based elastomer, and a polyester; preferably a styrenic thermoplastic elastomer (different from the sole main material), preferably SEBS or SBS. The sole may comprise a second sole auxiliary material which is a polyolefin, for example PP or PE.

In one embodiment, the sole main material is a vulcanized thermoplastic elastomer, optionally the sole further comprises a first sole auxiliary material, in particular a styrenic thermoplastic elastomer, for example SEBS or SBS, possibly grafted.

Preferably, the mass fraction of the sole main material in the sole is greater than or equal to 40% and less than or equal to 85%, still preferably greater than or equal to 30%, preferably greater than or equal to 40%, in particular greater than or equal to 55%.

Preferably, the mass fraction of the first sole auxiliary material in the sole is greater than or equal to 8%, still preferably less than or equal to 30%, for example comprised between 15% and 25%.

In one embodiment, the sole main material is polypropylene.

Preferably, the mass fraction of the sole main material in the sole is greater than or equal to 50%, still preferably greater than or equal to 80%, in particular greater than or equal to 90%, for example in the range of 100%.

Preferably, when the sole comprises one or several sole auxiliary material(s), this/these is/are preferably embedded, such as one/several filler(s), in a polymer matrix formed by the sole main material.

The sole according to the present disclosure may be/may comprise an outsole or an intermediate sole or a combination of these.

In one embodiment, the footwear comprises an outsole and an intermediate sole, in particular the intermediate sole is a removable sole.

The intermediate sole may be removably arranged in a foot receiving room of the footwear so as to lie beneath the foot of the user.

The intermediate sole may also serve as a sockliner.

The sole according to the present disclosure may comprise (be constituted of) one or several sole component(s) comprising (in particular constituted of) the sole main material and/or one or several sole auxiliary material(s).

A sole component may be an outsole, an intermediate sole, a first sockliner, a damping heel component (for example a donut), a textile component (as defined hereinbefore with reference to the shaft), a functional device conferring stability, or else a reinforcing or damping insert, or a cellular component, in particular a foam or a set of beads foamed and possibly agglomerated and/or glued.

In one embodiment, the sole comprises/is an intermediate sole comprising an external face coming in direct contact with the ground.

Advantageously, the intermediate sole is configured to ensure the outsole function. Hence, the footwear does not comprise any outsole.

Preferably, the intermediate sole is a single-block component.

Preferably, a formed intermediate sole having a good resistance to abrasion will be selected.

In one embodiment, the sole comprises an outsole component, preferably comprises (or is) an outsole, having a density (g/cm3) greater than or equal to 0.85; preferably less than or equal to 1.30.

In one embodiment, the sole comprises an intermediate sole component, preferably comprises (or is) an intermediate sole, having a density (g/cm3) greater than or equal to 0.10; preferably less than or equal to 0.90; still preferably having a density less than or equal to 0.50; in particular less than or equal to 0.40.

In one embodiment, the sole comprises an intermediate sole component, preferably comprises (or is) an intermediate sole, having a density (g/cm3) greater than 0.50 and less than or equal to 0.85; in particular less than or equal to 0.75.

In one embodiment, the footwear comprises an injected outsole, in particular comprising the sole main material (for example SEBS possibly grafted) and possibly a first sole auxiliary material (for example PP or PE), and an intermediate sole injected, in particular directly over the outsole still in a softened state.

The intermediate sole comprises the sole main material (for example SEBS possibly grafted) and possibly the first sole auxiliary material (for example PP or PE), mixed with at least one foaming agent. The outsole and the intermediate sole are manufactured by bi-injection.

In one embodiment, the shoe comprises a first sockliner, in particular arranged in the foot receiving room of the shoe so as to lie under the foot when the shoe is worn.

Preferably, the first sockliner is removable.

This arrangement is advantageous when the sole is injected over the shaft. Indeed, when a first sockliner is already present during the injection process, the latter may be crushed and thus lose its foot receiving properties. The use of a first removable sockliner allows overcoming this problem.

Advantageously, the first sockliner may comprise agglomerated beads made of foam, still preferably the beads made of foam comprise (in particular consist of) a material selected from among polyolefins, styrenic thermoplastic elastomers, olefinic thermoplastic elastomers, vulcanized thermoplastic elastomers, thermoplastic polyurethanes (TPU), polyamides, an ether-amide block copolymer (PEBA), an ethylene-vinyl acetate (EVA), an ether-ester block copolymer, a styrene-based elastomer, and a polyester, or a combination of these.

In particular, the first sockliner may comprise a foam comprising a polyolefin, in particular a polyethylene. The foam may be laminated with a textile, possibly between two textiles. The or the textile(s) comprising wires and/or fibers made of polyolefin.

Shaft and/or Sole Main and/or Auxiliary Material(s)

### Polyolefins

The polyolefin(s) mentioned in the present text, in particular for the shaft main material and/or the sole main material and/or the shaft and/or sole auxiliary material(s), is/are selected from among homopolymers of polyolefins, possibly grafted, copolymers or terpolymers of polyolefins, possibly grafted.

Copolymers of polyolefins comprise two olefinic repeat units, possibly grafted.

Terpolymers of polyolefins comprise three or more olefinic repeat units, possibly grafted.

Preferably, the olefinic repeat units comprise alkene, in particular ethylene or propylene, derived units.

By definition, the polyolefin(s) implemented in the present disclosure is/are thermoplastic.

By grafted, it should be understood one or more grafted function(s) or one or more grafted group(s) which may consist of one or more alkyl group(s), linear or branched, comprising from 1 to 10 carbon atoms, preferably from 1 to 5 carbon atoms, for example a methyl group, an ethyl or propyl group, or one or more ester function(s), for example an alkyl ester whose alkyl group comprises from 1 to 5 carbon atoms, or else one or more acrylate (R—O—CO—CH═CH2) or acryloyl (H2C═CH—CO—R) function(s), in particular R is an alkyl group comprising from 1 to 10 carbon atoms.

The polyolefin(s) mentioned in the present text, in particular for the shaft main material and/or the sole main material and/or the shaft and/or sole auxiliary material(s), is/are preferably selected in a list I comprising (in particular consisting of) polypropylene; polyethylene, in particular high-density polyethylene, very high-density polyethylene, low-density polyethylene, and very low-density polyethylene (LLDPE); polymethylpentene (PMP), polybutene-1 (PB-1), polyisobutene; preferably from among polypropylenes and polyethylenes, in particular the polyethylene is selected from among high-density polyethylene, very high-density polyethylene, low-density polyethylene, and very low-density polyethylene (LLDPE).

The polyolefin(s) mentioned in the present text, in particular for the shaft main material and/or the sole main material and/or the shaft and/or sole auxiliary material(s), may also be selected from among a list II comprising (in particular consisting of) poly(ethylene-vinyl acetate) (EVA) (in particular derived from the copolymerization of ethylene and vinyl acetate, it consists of a copolymer of olefins), in particular not crosslinked; poly(ethylene vinyl alcohol).

The polyolefin(s) mentioned in the present text for the sole main material and/or the sole auxiliary material(s) may be selected from among mineral oils based on olefin(s), such as poly-alpha-olefins, in particular which consist of plasticizers of styrenic thermoplastic elastomers.

The polyolefin may be a bio-sourced or petrochemical polyolefin, in particular bio-sourced, i.e. derived from a renewable material, for example it may consist of a bio-sourced polyethylene derived from sugarcane.

By bio-sourced material, it should be understood any material derived from renewable material(s), in contrast with the petrochemical material.

The bio-sourced polyolefin may have a so-called direct origin, i.e. it is derived directly from renewable materials, or an indirect origin, i.e. it is derived from a mixture of renewable material(s) and petrochemical material(s) and/or recycled material(s). In the last case, the polyolefin is defined by the obtainment of a certificate established according to the “mass balance approach” principle defining the proportion of recycled and/or bio-sourced material(s) used to obtain it.

### Olefinic Thermoplastic Elastomer

A/the olefinic thermoplastic elastomer(s) mentioned in the present text, in particular for the shaft main material and/or the sole main material and/or the shaft and/or sole auxiliary material(s), is/are selected from among:
polyisobutylenes (PIB); and/or
ethylene, propylene, and diene terpolymers (EPDM); ethylene and propylene copolymers; ethylene and alpha-olefin copolymers, for example ethylene and butene copolymers or ethylene and octene copolymers, and a mixture of these; preferably EPDM and ethylene and propylene copolymers; and/or
mixtures of a polyolefin, in particular polypropylene, with one or more olefinic thermoplastic elastomer(s), non-vulcanized, and possibly one or more plasticizer(s), the or the olefinic thermoplastic elastomer(s) may consist of ethylene and propylene copolymers, ethylene, propylene and diene terpolymers, ethylene and alpha-olefin copolymers (for example ethylene and butene copolymers or ethylene and octene copolymers).

### Vulcanized Thermoplastic Elastomers

A/the vulcanized thermoplastic elastomer(s) (TPE-V) mentioned in the present text, in particular for the shaft main material and/or the sole main material and/or the shaft and/or sole auxiliary material(s), is/are preferably:
a mixture of a vulcanized olefinic elastomer (in particular forming the rubber phase) and of a polyolefin (in particular as defined in the present text, more particularly forming the thermoplastic phase), in particular polypropylene, or
a mixture of a vulcanized olefinic elastomer (in particular as defined in the present text and vulcanized, more particularly forming the rubber phase) and of a styrenic thermoplastic elastomer (in particular as defined in the present text, more particularly forming the thermoplastic phase), in particular SEBS or SBS

In general, the vulcanization takes place during the extrusion-granulation step. Preferably, the highly-vulcanized rubber phase is scattered in the thermoplastic phase. This elastomer has the advantage of having a good adhesion to olefinic polymers, such as polypropylene and polyethylene. This vulcanization is known in the prior art like a dynamic vulcanization during which the elastomer is vulcanized during mixing thereof in the molten state with a suitable thermoplastic polyolefin.

Preferably, the vulcanized olefinic elastomer is selected from among ethylene, propylene, and diene terpolymers (EPDM); ethylene and propylene copolymers; ethylene and alpha-olefin copolymers, for example ethylene and butene copolymers or ethylene and octene copolymers, and a mixture of these; preferably EPDM and ethylene and propylene copolymers

In the present text, it is considered that polyurethanes are not vulcanized thermoplastic elastomers.

### Styrenic Thermoplastic Elastomers

A/the styrenic thermoplastic elastomer(s) mentioned in the present text, in particular for the shaft main material and/or the sole main material and/or the shaft and/or sole auxiliary material(s), is/are preferably selected from among thermoplastic elastomers comprising styrenic repeat units (TPE-S) (in particular a styrene group: —CH(C6H5)-CH2), still preferably from among the thermoplastic elastomers comprising one or more styrenic block(s) and optionally one or more olefin block(s) (possibly grafted), preferably from among poly(styrene-ethylene-butylene-styrene) (SEBS); poly(styrene-butadiene-styrene) (SBS); poly(styrene-butadiene) (SBC); poly(styrene-isoprene-styrene) (SIS); poly(styrene-ethylene-propylene-styrene) (SEPS), for example commercialized under the brand Septon SEP® by the Kuraray company, or Kraton G® by the Kraton company.

A styrenic thermoplastic elastomer according to the present disclosure may be grafted, for example SEBS may be grafted, for example with one or more acid anhydride(s), such as maleic anhydride, and/or one or more carboxylic acid(s) and/or one or more vinyl function(s).

Grafting the styrenic thermoplastic elastomer is intended to improve the adhesion of the sole, for example the outsole, to another sole, for example an intermediate sole, and/or to the shaft when the sole is injected directly over the shaft.

Advantageously, the thermoplastic elastomers selected in the context of the present disclosure have a better transformability and a lower associated energy cost than thermosetting elastomers by conventional thermoplastic processes like injection molding, extrusion, thermoforming, blowing, etc.

In particular, mention may be made of polyolefins, styrenic thermoplastic elastomers, olefinic thermoplastic elastomers, vulcanized thermoplastic elastomers, thermoplastic polyurethanes (TPU), polyamides, an ether-amide block copolymer (PEBA), an ethylene-vinyl acetate (EVA), an ether-ester block copolymer, a styrene-based elastomer, and a polyester.

### DEFINITIONS

Advantageously, the shaft main material and/o the sole main material, and possibly one or several shaft auxiliary material(s) and/or one or several sole auxiliary material(s), has or have (in particular each) a melting point (Tf) and/or a glass-transition temperature (Tg), in particular the melting point(s) is/are higher than the glass-transition temperature(s).

In the present text, by shoe, it should be understood any footwear excluding boots.

In the present text, by boot, it should be understood a rain boot or a snow boot or a clog, in particular a footwear comprising a shaft and a sole portion comprising a common polymer material forming most of the mass of the shaft and of the sole, the shaft and the sole being molded together.

In the present text, by thermoplastic material, it should be understood any material that could be softened or molten by heating, and that being so in a sufficient manner, without degradation of the latter, so that it could be implemented in a method for transforming a plastic, such as those mentioned hereinbefore, and that being so several times.

By most of the mass of the shaft, it should be understood that:
the mass fraction of the shaft main material measured with respect to the total mass of the shaft, is greater than the mass fraction of any other material that the shaft comprises; or
the mass fraction of the shaft main material plus the respective mass fraction(s) of the shaft auxiliary material(s), measured with respect to the total mass of the shaft, is greater than the mass fraction of any other material that the shaft comprises and not selected in the main list defined in the present text; or
the surface fraction occupied by the shaft main material measured with respect to the total surface of the shaft is greater than the surface fraction occupied by any other material that the shaft comprises; or
the surface fraction occupied by the shaft main material plus the respective surface fraction(s) of the shaft auxiliary material(s), measured with respect to the total surface of the shaft is greater than the surface fraction occupied by any other material that the shaft comprises and not selected in the main list defined in the present text.

Thus, the shaft main material, and possibly the shaft auxiliary material(s) may represent for example 30 weight %, 40 weight % or 50 weight % or 60 weight % of the shaft or of the external surface of the shaft.

By shaft main material, it should be understood that the mass or surface fraction of the shaft main material is greater than the mass or surface fraction of any shaft auxiliary material, and possibly greater than the mass or surface fraction of any other material that the shaft comprises not selected in the main list defined in the present text.

When the shaft main material represents for example 30% of the mass of the shaft, the auxiliary material(s) represents (each) less than 30% of the mass of the shaft.

Preferably, the external surface of the shaft is calculated from a shaft projected flat. For example, it may consists of the surface of the blank of the shaft before there-dimensional shaping thereof by stitching, but comprising all of the shaft components arranged over its external surface.

By total mass of the shaft, it should be understood the mass of the shaft on the end shoe with all of its components.

By most of the mass of the sole, it should be understood that:
the mass fraction of the sole main material, measured with respect to the total mass of the sole, is greater than the mass fraction of any other material that the sole comprises; or
the mass fraction of the sole main material added to the respective mass fraction(s) of the sole auxiliary material(s), measured with respect to the total mass of the sole, is greater than the mass fraction of any other material that the sole comprises that is not selected from the main list defined hereinabove in the present text.

Thus, the sole main material, and possibly the sole auxiliary material(s) may represent 40 weight % or else 50 weight % or 60 weight % of the sole.

By sole main material, it should be understood that the mass fraction of the sole main material is greater than the mass fraction of any sole auxiliary material, and possibly greater than the mass fraction of any other sole material that is not selected in the main list defined in the present text.

For example, when the sole main material represents 30 weight % of the sole, the auxiliary material(s) represents (each) less than 30 weight % of the sole.

In the present text, the mass fraction of a shaft main or auxiliary material in the shaft is the ratio of the mass (g) of the shaft main or auxiliary material to the total mass (g) of the shaft.

For the calculation of the total mass of the shaft in order to define the mass fraction(s) of the shaft main materials and/or of the shaft auxiliary material(s), it is considered that all of the shaft material(s) cover the top of the foot, i.e. arranged above the bearing plane of the foot. The possible material(s) of the sole in connection with the shaft (sole portion of a knitted sock for example) is/are counted as belonging to the sole, in particular the intermediate sole or the outsole.

In the present text, the surface fraction occupied by the shaft main or auxiliary material is the ratio of the surface occupied (cm²) by the visible material to the external total surface (cm²) of the shaft projected flat, the external surface of the shaft being that one directed outwardly of the shoe.

In the present text, the mass fraction of a sole main or auxiliary material in the sole is the ratio of the mass of the main or auxiliary material to the total mass of the sole.

When a first shaft component comprises the shaft main material and a second shaft component comprises the shaft main material, each of the first component and the second component comprises a shaft main material in the same base polymer, which may be selected from among polyolefins, styrenic thermoplastic elastomers, olefinic thermoplastic elastomers, vulcanized thermoplastic elastomers, thermoplastic polyurethanes (TPU), polyamides, an ether-amide block copolymer (PEBA), an ethylene-vinyl acetate (EVA), an ether-ester block copolymer, a styrene-based elastomer, and a polyester; and in particular a polyolefin, for example PP or PE. However, the base polymer material of the first component may be different from the base polymer material of the second component by the hardness or its intrinsic properties (molar mass, degree of polymerization, amount of monomer(s)) or its form (foam, textile, foamed beads, . . . ).

The footwear, in particular the shaft and/or the sole, may comprise at most about 20 weight %, in particular at most 15 weight %, more particularly at most 10 weight %, in particular at most 5 weight %, with respect to its total mass, of one or several contaminant material(s), i.e. is/are not selected from among polyolefins, styrenic thermoplastic elastomers, olefinic thermoplastic elastomers and vulcanized thermoplastic elastomers. The or the contaminant material(s) may be selected from among polyurethanes, polyamides or polyesters (for example polyethylene terephthalate (PET), or polybutylene terephthalate (PBT)). For example, these contaminant materials may be derived from recycled materials.

In one sub-variant, the footwear is a boot. The boot comprises an outsole and a shaft. The shaft comprises a lower shaft portion covering the foot, in particular the forefoot, the instep, the medial region, the lateral region, and the hindfoot. The shaft also comprises an upper shaft portion covering at least partially the leg.

Preferably, the shaft lower portion and the outsole are co-injected.

In both of the previous sub-variants, preferably, the sole main material is styrenic thermoplastic elastomer, in particular a SEBS, and the shaft main material is a styrenic thermoplastic elastomer.

The shaft upper portion comprises one or several foam(s) and one or several textile(s) made of at least one shaft auxiliary material, in particular selected from among polyolefins. The shaft may also comprise one or more foam(s) and/or one or more textile(s) forming an inner slipper arranged in the room for receiving the foot of the boot and covering all or part of the inner face of the injected shaft lower portion.

Preferably, the mass fraction of the sole main material in the sole is greater than or equal to 45%, still preferably greater than or equal to 50%, in particular less than or equal to 70%.

The outsole may also comprise a first sole auxiliary material, which could be selected from among polyolefins, styrenic thermoplastic elastomers, olefinic thermoplastic elastomers, vulcanized thermoplastic elastomers, thermoplastic polyurethanes (TPU), polyamides, an ether-amide block copolymer (PEBA), an ethylene-vinyl acetate (EVA), an ether-ester block copolymer, a styrene-based elastomer, and a polyester; and for example a polyolefin, in particular polypropylene.

The mass fraction of the first sole auxiliary material in the sole is greater than or equal to 5% and less than or equal to 40%, in particular less than or equal to 30%.

Preferably, the mass fraction of the shaft main material is greater than or equal to 40%, still preferably less than or equal to 60%.

The shaft may comprise a first shaft auxiliary material which is a polyolefin, in particular polypropylene, whose mass fraction in the shaft is greater than or equal to 10%, preferably less than or equal to 35%.

Preferably, the ratio of the mass of the shaft main material and of the mass of the first shaft auxiliary material to the total mass of the shaft is greater than or equal to 60%, still preferably greater than or equal to 70%.

In one variant, the shaft main material is selected from among one of the following materials: a polyolefin, an olefinic thermoplastic elastomer, or a vulcanized thermoplastic elastomer, preferably from among a polyolefin or an olefinic thermoplastic elastomer, still preferably a polyolefin.

In one variant, the sole main material is selected from among one of the following materials: a styrenic thermoplastic elastomer, a polyolefin, or a vulcanized thermoplastic elastomer.

In one variant, the sole main material is a styrenic thermoplastic elastomer.

In one variant, the sole main material is a polyolefin, in particular polypropylene.

In one variant, the shaft comprises a wire comprising a material selected from among polyolefins, styrenic thermoplastic elastomers, olefinic thermoplastic elastomers, vulcanized thermoplastic elastomers, thermoplastic polyurethanes (TPU), polyamides, an ether-amide block copolymer (PEBA), an ethylene-vinyl acetate (EVA), an ether-ester block copolymer, a styrene-based elastomer, and a polyester.

Preferably, the polyolefin is polypropylene or polyethylene.

Preferably, the wire comprises the shaft main material.

In one variant, the shaft comprises a textile component, and the textile component comprises a wire comprising the shaft main material, in particular the shaft main material is selected from among polyolefins, styrenic thermoplastic elastomers, olefinic thermoplastic elastomers, vulcanized thermoplastic elastomers, thermoplastic polyurethanes (TPU), polyamides, an ether-amide block copolymer (PEBA), an ethylene-vinyl acetate (EVA), an ether-ester block copolymer, a styrene-based elastomer, and a polyester.

Preferably, the shaft main material is propylene or polyethylene. In one variant, the shaft comprises a textile portion forming an area for receiving the foot having an outer face, and at least one part, in particular a strip, comprising an olefinic thermoplastic elastomer, the part being secured, to the outer face of the textile portion, and to the sole.

Advantageously, the textile portion forming an area receiving the foot comprises a textile component, in particular comprising a wire comprising the shaft main material selected from among polyolefins, styrenic thermoplastic elastomers, olefinic thermoplastic elastomers, vulcanized thermoplastic elastomers, thermoplastic polyurethanes (TPU), polyamides, an ether-amide block copolymer (PEBA), an ethylene-vinyl acetate (EVA), an ether-ester block copolymer, a styrene-based elastomer, and a polyester; more particularly, the shaft main material is a polyolefin or an olefinic thermoplastic elastomer or a vulcanized thermoplastic elastomer.

Advantageously, the textile component may be as described in the present text. Preferably, the part is a leatherette-made part.

Advantageously, the part comprises a textile support and a polymeric layer comprising, in particular essentially constituted of, more particularly constituted of a material selected from among polyolefins, styrenic thermoplastic elastomers, olefinic thermoplastic elastomers, vulcanized thermoplastic elastomers, thermoplastic polyurethanes (TPU), polyamides, an ether-amide block copolymer (PEBA), an ethylene-vinyl acetate (EVA), an ether-ester block copolymer, a styrene-based elastomer, and a polyester; and in particular the olefinic thermoplastic elastomer, the polymeric layer being secured to the textile support.

Still advantageously, the face of the part comprising the textile support is oriented opposite the outer face of the textile portion.

Preferably, the shaft comprises one or several strip(s), still preferably arranged to run, at least partially, along at least one of the following edges of the shoe: the front edge, the medial edge, the lateral edge, and the rear edge.

Preferably, the or the part(s), in particular strip(s), is/are secured to the outer face of the textile portion forming an area for receiving the foot, and to the sole.

Preferably, the or the party(s), in particular strip(s), has/have (in particular each) a thickness larger than or equal to 0.5 mm and smaller than or equal to 3 mm.

Preferably, the at least one part, in particular a strip, is secured to the outer face of the textile portion, and possibly to the sole, by meltdown of at least one portion of its structure.

Preferably, at least one portion of the at least one part, in particular a strip, is arranged between the sole and the outer face of the textile portion for receiving the foot.

Advantageously, the olefinic thermoplastic elastomer allows forming a reinforcing part, in particular a reinforcing strip, having a leatherette aspect, which is compatible with the polymer material(s) of the textile portion and of the sole so that it could be glued by melting.

In one embodiment, the part is arranged so as to form a portion overlapping all or part of the forefoot, in particular comprises an opening for inserting the foot in the overlapping portion.

In one variant, the sole comprises a cellular component, in particular a foam, comprising a material selected from among the following materials: polyolefins, styrenic thermoplastic elastomers, olefinic thermoplastic elastomers, thermoplastic polyurethanes (TPU), polyamides, an ether-amide block copolymer (PEBA), an ethylene-vinyl acetate (EVA), an ether-ester block copolymer, a styrene-based elastomer, and a polyester; and in particular a styrenic thermoplastic elastomer, an olefinic thermoplastic elastomer, or a polyolefin, preferably from among one of the following materials: an olefinic thermoplastic elastomer, still preferably an olefinic thermoplastic elastomer.

Preferably, the beads made of foam are agglomerated in one block, in particular are glued together at their surfaces by melting.

Preferably, the cellular component has a volumetric density comprised between 0.1 g/cm3 and 0.4 g/cm3, preferably between 0.15 g/cm3 and 0.25 g/cm3.

Preferably, the cellular component is an intermediate sole.

In one variant, the shaft comprises a front hard tip comprising the shaft main material or a shaft auxiliary material, and/or a rear buttress comprising the shaft main material or a shaft auxiliary material.

The shaft may comprise a rear buttress or a front hard tip comprising, or constituted of, a material selected from among polyolefins, styrenic thermoplastic elastomers, olefinic thermoplastic elastomers, thermoplastic polyurethanes (TPU), polyamides, an ether-amide block copolymer (PEBA), an ethylene-vinyl acetate (EVA), an ether-ester block copolymer, a styrene-based elastomer, and a polyester.

Thus, the shaft may comprise a rear buttress or a front hard tip comprising, or constituted of, a styrenic thermoplastic elastomer, for example SEBS, possibly mixed with at least one polyolefin.

The shaft may comprise a rear buttress or a front hard tip comprising, or constituted of, a vulcanized thermoplastic elastomer.

In one variant, the shaft comprises at least one loop for the passage of at least one lacing element, the at least one passage loop comprises a textile strip comprising at least one wire comprising the shaft main material or a shaft auxiliary material, in particular the shaft main material is a polyolefin.

In one variant, the shaft comprises a component made of foam comprising the shaft main material, in particular the shaft main material is selected from among polyolefins, styrenic thermoplastic elastomers, olefinic thermoplastic elastomers, thermoplastic polyurethanes (TPU), polyamides, an ether-amide block copolymer (PEBA), an ethylene-vinyl acetate (EVA), an ether-ester block copolymer, a styrene-based elastomer, and a polyester.

The shaft may comprise one or several complex(es), a complex comprising a textile secured with the component made of foam, preferably the textile and the component made of foam comprise (in particular are constituted of) the shaft main material, selected from among polyolefins, styrenic thermoplastic elastomers, olefinic thermoplastic elastomers, thermoplastic polyurethanes (TPU), polyamides, an ether-amide block copolymer (PEBA), an ethylene-vinyl acetate (EVA), an ether-ester block copolymer, a styrene-based elastomer, and a polyester; preferably made of polyolefin, for example of PP or of PE.

The component made of foam, possibly assembled with a textile, may be arranged in the heel rear region of the shaft in order to confer comfort and/or in a medial region of the shaft and/or in a lateral region of the shaft.

In one variant, the shaft and/or the sole, comprises/each comprises, a recycled material of a sole and/or of the shaft of another shoe, and/or a recycled material of a sole and/or of the shaft of a boot.

Preferably, the recycled material comprises the shaft main material and/or the sole main material and/or the shaft and/or sole auxiliary material(s).

The other shoe may be a shoe according to the present disclosure.

In one variant, the mass of the shaft main material, and possibly the mass of the shaft auxiliary material(s), to the total mass of the shaft is greater than or equal to 40%, preferably greater than or equal to 50%. In one variant, the ratio of the mass of the shaft main material and of the mass of the shaft auxiliary material(s), to the total mass of the shaft is greater than or equal to 50%, and the saft main material and the shaft auxiliary material(s) are selected from among polyolefin and olefinic thermoplastic elastomers. In one variant, the sole main material covers at least partially the shaft, in particular the shaft main material.

Preferably, the sole main material rises substantially over the forefoot region and/or over the hindfoot region and/or over the medial region and/or over the lateral region of the shaft.

In one variant, the sole main material is secured to the shaft, in particular to the shaft main material, without any intermediate bonding agent, for example without any gluing agent or any stitch. In one variant, the mass of the sole main material, and possibly the mass of the sole auxiliary material(s), to the total mass of the sole is greater than or equal to 40%, preferably greater than or equal to 50%.

In one variant, the ratio of the mass of the sole main material and of the mass of the sole auxiliary material(s), to the total mass of the sole is greater than or equal to 50%, and the sole main material and the sole auxiliary material(s) are selected from among polyolefins, styrenic thermoplastic elastomers, olefinic thermoplastic elastomers, thermoplastic polyurethanes (TPU), polyamides, an ether-amide block copolymer (PEBA), an ethylene-vinyl acetate (EVA), an ether-ester block copolymer, a styrene-based elastomer, and a polyester.

In one variant, the footwear, in particular the shoe, in particular the sports shoe, or else the shaft and/or the sole of the footwear, in particular of the shoe, comprises/comprise (in particular each):
at most 10 weight % by one or several contaminant material(s) that are not selected from among polyolefins, styrenic thermoplastic elastomers, olefinic thermoplastic elastomers, thermoplastic polyurethane (TPU), polyamides, an ether-amide block copolymer (PEBA), an ethylene-vinyl acetate (EVA), an ether-ester block copolymer, a styrene-based elastomer, and a polyester,
in particular at most 10 weight % of one or several thermoplastic contaminant material(s) and/or at most 5 weight % of one or several thermosetting contaminant material(s).

For example, if the contaminant material(s) is/are constituted of thermoplastic contaminant material(s), the mass fraction of contaminant(s) in the shoe amounts to at most 10%.

For example, if the shoe comprises 5 weight % of one or several thermosetting contaminant material(s), the shoe may also comprise at least 5 weight % of one or several thermoplastic contaminant material(s).

In one variant, the footwear, in particular the shoe, in particular the sports shoe, or else the shaft and/or the sole of the footwear, in particular of the shoe, comprises/comprise (in particular each):
one or several contaminant material(s).

In one variant, the footwear, in particular the shoe, in particular the sports shoe, or else the shaft and/or the sole of the footwear, in particular of the shoe, comprises/comprise (each):
at most 10 weight % of one or several contaminant material(s),
in particular at most 10 weight % of one or several thermoplastic contaminant material(s) and/or at most 5 weight % of one or several thermosetting contaminant(s).

In the present text, by thermosetting material, in particular contaminant thermosetting material, it should be understood any material that does not have a temperature of hot transformation by a plastic shaping process, for example by extrusion-injection, extrusion-blowing, hot-pressing (thermocompression), extrusion-spinning.

In the present text, by thermoplastic material, in particular thermoplastic contaminant material, it should be understood any material having a temperature of hot transformation by a plastic shaping process, for example by extrusion-injection, extrusion-blowing, hot-pressing, extrusion-spinning.

Advantageously, the inventors have determined that, depending on whether they are thermoplastic or thermosetting, the contaminant levels should not exceed some proportions in the footwear for the latter to be recyclable without separation of its different components and for the final recycled material to have satisfactory mechanical properties in many new applications.

A non-comprehensive, in particular with regards to the thermosetting contaminants, explanation is that the contaminant material(s) is/are arranged like nodules in the thermoplastic matrix derived from the shaft and sole main materials, and possibly from their auxiliary materials.

In addition, the Inventors have determined that the properties of the polymeric mixture derived from a footwear could surprisingly be improved by a contaminant material.

In particular, the resistance to abrasion of the mixture is surprisingly improved when the shoe comprises one or several contaminant materials made of polyurethane or of polyamide, in particular whose mass fraction is at most 10% in the shoe (cf. table of the appended FIG. 5). Beyond 10%, it has been observed that the resistance to abrasion decreases.

Preferably, the mass fraction of contaminant material(s) in the footwear is then greater than or equal to 0.5%, still preferably greater than or equal to 1%.

In one variant, the footwear, in particular the shoe, in particular a sports shoe, or else the shaft and/or the sole of the footwear, in particular of the shoe, comprises/comprise (in particular each) a foam in a contaminant material.

In one embodiment, the sole or the shaft comprises a foam in a contaminant material which represents at least 30% by volume, preferably at least 40% by volume, still preferably at least 50% by volume, preferably at least 60% or 70% by volume, of the sole or of the shaft.

In one embodiment, the foam in a contaminant material represents at most 10 weight % of the footwear, in particular of the shoe, when the contaminant material is thermoplastic, and/or at most 5 weight % of the footwear, in particular of the shoe, when the contaminant material is thermosetting.

The foam may be a foamed block or else comprise agglomerated expanded particles.

For example, the density of a foam made of polyurethane ranges from 0.040 Kg/liter to 0.4 Kg/liter, for example in the range of 0.055 Kg/liter while the density of a styrenic thermoplastic elastomer, such as SEBS, is greater than or equal to 0.80 Kg/liter.

In one embodiment specific to polyesters, the present disclosure relates to a footwear, in particular a shoe, more particularly a sports shoe, advantageously comprising, more advantageously constituted essentially by, even more advantageously constituted of:
a shaft, most of the mass of the shaft or most of the surface of the shaft being made of a shaft main material, the shaft possibly further comprising one or several shaft auxiliary material(s);
a sole, most of the mass of the sole being made of a sole main material, the sole possibly further comprising one or several sole auxiliary material(s);
and characterized in that the shaft main material, and possibly the shaft auxiliary material(s), is/are selected from among polyesters and materials chemically compatible with polyesters;
and in that the sole main material, and possibly the sole auxiliary material(s), is/are selected from among polyesters and materials chemically compatible with polyesters.

The shaft main material may comprise at least one amongst the following materials: a thermoplastic copolyester, polyethylene terephthalate.

The thermoplastic copolyester may be a block copolymer comprising rigid segments of polyester and soft segments of polyether and/or polyester, and in particular TPEE or TPC-ET.

The shaft may comprise a lower portion comprising a thermoplastic copolyester which is a block copolymer comprising rigid segments of polyester and soft segments of polyether and/or polyester, and in particular TPEE or TPC-ET.

The shaft may comprise an upper portion which comprises polyethylene terephthalate or a thermoplastic copolyester which is a block copolymer comprising rigid segments of polyester and soft segments of polyether and/or polyester, for example TPEE.

The upper portion may comprise an upper layer made of polyethylene terephthalate, a lower layer made of polyethylene terephthalate, a central layer made of a thermoplastic copolymer and surrounded at the top and at the bottom by an adhesive intermediate layer, an upper intermediate layer of which arranged between the central layer and the upper layer, and a lower intermediate layer of which arranged between the central layer and the lower layer. The adhesive intermediate layers allow bonding the different layers together. The adhesive intermediate layer may be made of polyethylene terephthalate.

The shaft may comprise a lace made of polyethylene terephthalate.

The shaft may comprise lacing loops, for example made in the form of a wire embroidered over the shaft. The lacing loops may be made of polyethylene terephthalate.

The shaft may comprise an upper reinforcement made of unwoven polyethylene terephthalate.

The shaft may comprise a tab made of unwoven polyethylene terephthalate.

The footwear may comprise, at the rear of the footwear and above an intermediate sole, a reinforcing ring made of a thermoplastic copolyester.

The sole main material may comprise at least one amongst the following materials: a thermoplastic copolyester, a thermoplastic vulcanizate (TPV) type thermoplastic elastomer comprising a soft phase and a thermoplastic phase made of a thermoplastic copolyester.

The thermoplastic vulcanizate (TPV) type thermoplastic elastomer may comprise a soft phase made of poly(styrene/butadiene) and a thermoplastic phase made of a block copolymer comprising rigid segments of polyester and soft segments of polyether and/or polyester. Thus, the thermoplastic phase may be TPEE.

The sole may comprise an intermediate sole comprising a bloc copolymer comprising rigid segments of polyester and soft segments of polyether and/or polyester, and in particular TPEE or TPC-ET.

The sole may comprise an outsole comprising a thermoplastic vulcanizate (TPV) comprising a soft phase made of poly(styrene/butadiene) and a thermoplastic phase made of a block copolymer comprising rigid segments of polyester and soft segments of polyether, and in particular a thermoplastic phase made of TPEE.

Alternatively, the sole may comprise an outsole comprising rubber. In this case, the outsole is advantageously fastened on the intermediate sole using a specific gluing primer, which, when subjected to heat, allows easily disassembling the outsole in preparation for recycling of the shoe.

Finally, as regards this embodiment dedicated to polyesters as a main material, the footwear may comprise a first sockliner comprising a block copolymer comprising rigid segments of polyester and soft segments of polyether and/or polyester, and in particular TPEE or TPC-ET.

Sometimes, it is necessary to use some materials to confer particular function on the footwear, in particular when it consists of a sports shoe. The variants and embodiments according to a first aspect of the present disclosure may be combined independently of each other.

The injected sole may be an outsole or an intermediate sole or a combination of these.

In a first embodiment, the sole is injected directly over the shaft. Preferably, the shaft is arranged on a foot-like shaped preform, then the sole is injected over the lower portion of the shaft. The lower portion of the shaft may be a first mounting in connection with the lower edges of the shaft (for example when the shaft is three-dimensionally shaped using weld(s) and/or stitch(es) to cover the foot) and/or the textile sole portion of a shaft textile component. The shaft textile component may be a planar textile component, three-dimensionally shaped so as to form a slipper for receiving the foot, for example by stitching/welding.

The shaft textile component may be knitted sock comprising an integrated knitted sole portion, in particular hot-molten or thermos-compressed.

Preferably, securing the shaft and the sole together is performed without any gluing agent.

The selected sole and shaft main and/or auxiliary materials in the present disclosure allow manufacturing a sole by injecting it directly over a shaft with no adherence problems, thereby simplifying the process and reducing the number of the used different materials.

Preferably, the sole main material is selected from among polyolefins, styrenic thermoplastic elastomers, olefinic thermoplastic elastomers, thermoplastic polyurethanes (TPU), polyamides, an ether-amide block copolymer (PEBA), an ethylene-vinyl acetate (EVA), an ether-ester block copolymer, a styrene-based elastomer, and a polyester

The Applicant has observed that this sole main material has a very good adherence to the shaft main material, in particular when it consists of a polyolefin or an olefinic thermoplastic elastomer.

The mixture injected to manufacture the sole may further comprise the sole main material, a plasticizer and/or a filler (for example calcium carbonate) and/or one or more foaming agent(s) (for example in the case of the intermediate sole).

The plasticizer may be selected from among mineral oils and/or naphthenic or paraffinic oils.

The sole injected over the shaft may be an outsole or an intermediate sole. In this last case, at least one foaming agent is used mixed with the sole main material.

In one variant, the method comprises a step of treating at least one portion of the surface of the sole, in particular of the outsole and/or of the intermediate sole, and/or of at least one portion of the surface of the shaft, in particular of the surface of one or several textile component(s), so as to improve the adherence of the sole to the shaft and/or of the outsole to the intermediate sole and/or of a functional component (for example a lateral reinforcement, a front hard tip or a rear buttress) t the textile component(s) of the shaft.

The treatment step comprises a light abrasion step (referred to in particular as “buffing treatment”), and/or a plasma treatment step, and/or a flame treatment step, and/or a corona treatment step.

This step allows securing two components together, possibly without any gluing agent. Thus, we avoid the addition of a material that could turn out to be contaminant in the subsequent recycling processes.

In one variant, the sole main material, and possibly the sole auxiliary material(s), is/are derived at least partially from recycling of at least one other shoe or of at least one boot, in particular of at least one footwear according to any one of the variants or embodiments according to the first aspect of the present disclosure.

In one variant, the method comprises a step of foaming a component made of foam comprising the sole main material or at least one sole auxiliary material over the injected sole in a softened state so as to secure at least partially the component made of foam to the sole, in particular without any gluing agent.

The bi-injection may be performed as described hereinabove.

Securing the component made of foam and the sole together is performed when the injected sole is in a softened state, i.e. before it cools down to room temperature.

According to another aspect, the present disclosure relates to a method for recycling at least one footwear, in particular a shoe, comprising collecting at least one footwear, in particular a shoe, according to any one of the variants and embodiments according to a first aspect of the present disclosure, or obtained by implementing the manufacturing method according to any one of the variants and embodiments according to a second aspect of the present disclosure, and transforming the at least one footwear, in particular the shoe, into thermoplastic granules.

In a first step, the collected footwear, in particular the shoe, is shredded so as to obtain shreds, in particular having at least one dimension in the range of at least 1 mm to 40 mm. The shreds are conveyed into an extrusion-granulation device to obtain thermoplastic granules. Beforehand, they may undergo a washing step in order to pull off dust.

In the present text, by thermoplastic granules, it should be understood any granule having a hot transformation temperature by a plastic shaping process, for example by extrusion-injection, extrusion-blowing, hot-pressing, extrusion-spinning, injection with a supercritical fluid.

Thus, the thermoplastic granules have a thermoplastic material behavior when they are implemented in a hot transformation process, even though they comprise one or more thermosetting material(s) but in a small amount in order not to alter their ability to be transformed like thermoplastics.

Preferably, the extrusion-granulation device is/comprises a twin-screw extruder. Advantageously, this extruder type allows better mixing the shredded matter.

Advantageously, it is not necessary to separate the different components of the footwear, in particular of the shoe, because these are compatible with each other for implementation thereof in thermoplastic material transformation processes.

In one variant, the transformation step comprises, in particular in that order:
a step of shredding the footwear, in particular the at least one shoe (in particular sports shoe), to obtain shred particles;
a step of compacting the shred particles to obtain shred and compacted particles, in particular cold or hot compaction,
a step of extruding-granulating the shred and compacted particles to obtain granules that can be transformed by a plastic hot transformation process.

Advantageously, the compaction step allows venting air from the foamed and/or hollow recycled material(s).

Preferably, the compaction step is performed at hot temperature by heating the shred particles, in particular at a temperature higher than or equal to 60 °C and lower than or equal to 110 °C, for example in the range of 70 °C within a +/−10 °C margin.

In one variant, the recycling process comprises a step of transforming at least one portion of the thermoplastic granules at hot temperature for the manufacture of a plastic part, in particular partially forming an item for practicing a sport.

In the present text, by a plastic part forming at least partially an item for practicing a sport, it should be understood that the part could form only one portion or substantially the entirety of a sports item.

The plastic part comprises one or more recycled material(s), in particular originating from the recycled thermoplastic granules, selected from among polyolefins, olefinic thermoplastic elastomers, styrenic thermoplastic elastomers and vulcanized thermoplastic elastomers, possibly mixed with one or several other petrochemical and/or bio-sourced and/or recycled material(s) or not derived from the recycling method according to the present disclosure.

Advantageously, the plastic part is a swimming flipper, or a swimming flipper comprising a flipper and a room for receiving the foot.

The plastic part may be a grip, a zipper tab, a wheel, a lamp envelope, or a tuba mouthpiece.

The plastic part is not limited to recycling in a sports item but could be implemented in any application for which the composition of the recycled footwear has satisfactory mechanical properties

In the present text, by “plastic”, it should be understood any material based on the implementation of one or several (co)(ter)polymer(s) transformed by a hot process such as extrusion-injection, extrusion-molding, extrusion-blowing, thermocompression, or any equivalent technique.

According to a last aspect, the present disclosure relates to a plastic part (in particular molded, more particularly having a one-piece molded construction), in particular forming at least part of a footwear for practicing a sport, which can be obtained by the recycling method according to any one of the variants according to a third aspect of the present disclosure, in particular the part is a swimming flipper or a swimming flipper comprising a flipper and a room for receiving the foot.

In one embodiment, the part is a swimming flipper or a swimming flipper comprising a flipper and a room for receiving the foot, and the part comprises a mass predominant material selected from among polyolefins, styrenic thermoplastic elastomers, olefinic thermoplastic elastomers, thermoplastic polyurethanes (TPU), polyamides, an ether-amide block copolymer (PEBA), an ethylene-vinyl acetate (EVA), an ether-ester block copolymer, a styrene-based elastomer, and a polyester, preferably selected from among styrenic thermoplastic elastomers.

By mass predominant material, it should be understood that the mass fraction of the material is the greatest of the material(s) included in the composition of the part.

In one embodiment, the part comprises a mass predominant material selected from among polyolefins, styrenic thermoplastic elastomers, olefinic thermoplastic elastomers, thermoplastic polyurethanes (TPU), polyamides, an ether-amide block copolymer (PEBA), an ethylene-vinyl acetate (EVA), an ether-ester block copolymer, a styrene-based elastomer, and a polyester, the mass fraction of the mass predominant material in the part is greater than or equal to 10%, preferably greater than or equal to 25%, still preferably greater than or equal to 35%, preferably greater than or equal to 45%, in particular greater than or equal to 55%.

In one embodiment, the mass fraction of the recycled thermoplastic granules in the plastic part is greater than or equal to 10%, preferably greater than or equal to 25%, still preferably greater than or equal to 35%, preferably greater than or equal to 45%, in particular greater than or equal to 55%, possibly greater than or equal to 80% or 90%.

In another embodiment, the part comprises a recycled material elected from among polyolefins, styrenic thermoplastic elastomers, olefinic thermoplastic elastomers, thermoplastic polyurethanes (TPU), polyamides, an ether-amide block copolymer (PEBA), an ethylene-vinyl acetate (EVA), an ether-ester block copolymer, a styrene-based elastomer, and a polyester, preferably selected from among styrenic thermoplastic elastomers, the mass fractions of the recycled material in the part is less than or equal to 25%, preferably less than or equal to 20%, still preferably less than or equal to 15%. In one embodiment, the mass fraction of the recycled thermoplastic granules in the plastic part is less than or equal to 25%, preferably less than or equal to 20%, still preferably less than or equal to 15%.

According to one aspect, the present disclosure also relates to a footwear, for example a shoe, and in particular a footwear for practicing a sport, obtained by the method according to one of the previously-described implementations.

According to another aspect, the present disclosure concerns a device for the manufacture of at least one portion of a footwear, the device comprising a mold defining an open cavity, a shape of at least one portion of the cavity corresponding to a shape of a sole of the footwear, the cavity being configured to receive, via at least one injection channel opening into the cavity, a mixture comprising a molten material and a supercritical fluid, a rim of an opening of the open cavity being configured to be placed in contact with a docking area of a surface of at least one portion of a shaft of the footwear, so that the surface of the at least one portion of the shaft ensures closure of the cavity at the level of the contact between the docking area and the rim, so that the device is thus configured to implement the method according to one of the previously-described implementations.

According to one embodiment, the device further comprises a cap configured to be placed over the mold so as to form with the mold a closed volume comprising the cavity, and a complementary portion of the cavity in the closed volume, the at least one portion of the shaft of the footwear lying inside the closed volume, the complementary portion and the cavity lying on either side of the closure of the cavity at the level of the contact between the docking area and the rim, the device thus being configured to implement the method according to one of the above-described implementations.

According to one embodiment, the device further comprises a support having a shape corresponding to a shape of a foot, an outer surface of the support being configured to be covered with the at least one portion of the shaft of the footwear, the at least one portion of the surface of the at least one portion of the shaft covering a portion of the outer surface of the support corresponding to a sole of the foot.

### BRIEF DESCRIPTION OF THE DRAWINGS

For better understanding thereof, an embodiment and/or an implementation of the present disclosure is described with reference to the appended drawings representing, as a non-limiting example, an embodiment or implementation respectively of a device and/or of a method according to the present disclosure. The same references in the drawings refer to similar elements or elements whose functions are similar.

FIG. 1 is a perspective view of a mold, made in one-piece, of the cap corresponding to the mold, and of a shoe shaft mounted on a support, before the step of placing the shaft on the rim of the cavity of the mold, according to an implementation of the present disclosure.

FIG. 2 is a perspective view of a mold, made into three portions, of the cap corresponding to the mold, and of a shoe shaft mounted on a support, before the step of placing the shaft on the rim of the cavity of the mold, according to an implementation of the present disclosure.

FIG. 3 is a perspective view of a mold, made in one-piece, of the cap corresponding to the mold, and of a portion of a shaft of a shoe, before the step of placing the shaft portion on the rim of the cavity of the mold, according to an implementation of the present disclosure.

FIG. 4 is a perspective view of the portion of the shaft linked to a sole obtained after implementation of the method according to an implementation of the present disclosure, and of the shoe obtained after implementation of an additional step of assembling the portion of the shaft with another portion of the shaft.

FIG. 5 is a sectional view of a shaft with its support, placed over the mold, before the injection step, according to an implementation of the present disclosure; in this figure the cap of the mold is represented before placement thereof over the mold.

FIG. 6 is a sectional view of a shaft with its support, placed over the mold, under a cap forming with the mold a pressurized closed space on either side of the rim of the cavity of the mold, before the injection step, according to the implementation of the present disclosure of FIG. 5.

FIG. 7 is a perspective view of a shaft with its support, placed over the mold, before the injection step, according to the implementation of the present disclosure of FIGS. 5 and 6; in this figure the cap of the mold is represented before placement thereof over the mold.

FIG. 8 is a perspective view of the obtained shoe, with the support of the shaft, after implementation of the method according to the implementation of the present disclosure of FIGS. 5, 6 and 7.

FIG. 9 is a perspective view of a shaft support with a seal placed over an area of the support corresponding to a docking area of the surface of the portion of the shaft, according to the implementation of the present disclosure corresponding to FIGS. 5, 6, 7 and 8.

FIG. 10 is a perspective view of a shaft with an open surface at the level of the portion of the shaft intended to be embedded in the foamed material of the sole obtained according to an implementation of the present disclosure.

FIG. 11 is a perspective view of another shaft with a solid surface at the level of the portion of the shaft intended to be embedded in the foamed material of the sole obtained according to an implementation of the present disclosure.

FIG. 12 is a perspective view of another shaft with a solid surface at the level of the portion of the shaft intended to be embedded in the foamed material of the sole obtained according to an implementation of the present disclosure.

FIG. 13 is a perspective view of another shaft with a punctured or textured surface proximate to the docking area at the level of the portion of the shaft intended to be embedded in the foamed material of the sole obtained according to an implementation of the present disclosure.

FIG. 14 is a sectional view of a shaft with its support, placed over a mold comprising several injection channels, before the injection step, according to an implementation of the present disclosure.

FIG. 15 is a sectional view of a shaft with its support, placed over the mold, before the injection step, according to an implementation of the present disclosure wherein an injection channel crosses the support of the shaft.

FIG. 16 is a perspective view of inserts configured to be placed in the cavity of the mold so as to be associated with the sole obtained after overmolding with the foamed material, according to an implementation of the present disclosure.

FIG. 17 is a sectional view of a shaft with its support placed over the mold before the injection step, with the inserts placed in the cavity of the mold so as to be incorporated with the foamed material forming the sole, according to an implementation of the present disclosure.

FIG. 18 is a sectional view of a shaft with its support placed over the mold, after the injection step, with the inserts placed in the cavity of the mold and incorporated with the foamed material forming the sole, according to an implementation of the present disclosure.

FIG. 19 is a flowchart of the steps of the method, according to an implementation of the present disclosure.

FIG. 20 schematically illustrates in perspective a first example of a shoe that can be obtained by a method according to the present disclosure.

FIG. 21 represents the shoe of FIG. 20 according to the longitudinal sectional plane II-II represented in FIG. 20.

FIG. 22 schematically illustrates in perspective a second example of a shoe that can be obtained by a method according to the present disclosure.

FIG. 23 schematically illustrates in perspective a third example of a shoe that can be obtained by a method according to the present disclosure.

FIG. 24 is a detail sectional view of the shoe of FIG. 23.

FIG. 25 is a schematic representation of a contact surface of an insert, the contact surface comprising a texture comprising tubular or cylindrical patterns.

FIG. 26 is a schematic representation of a contact surface of an insert, the contact surface comprising a texture comprising linear patterns.

FIG. 27 is a schematic representation of a contact surface of an insert, the contact surface comprising a texture comprising at the center of the surface of the tubular or cylindrical patterns, and a linear pattern over the contour of the surface.

FIG. 28 is a perspective representation of a mold according to an embodiment.

FIG. 29 is a sectional representation of the mold according to the embodiment of FIG. 28.

FIG. 30 is a sectional representation of the steps of closure and opening of the mold according to the embodiment of FIG. 28.

FIG. 31 is a sectional representation of the steps of closure and opening of a variant of the mold according to the embodiment of FIG. 28.

FIG. 32 is a sectional view of a shaft with its support, placed over the mold, under a cap forming with the mold a pressurized closed space on either side of the rim of the cavity of the mold, with a pressurization channel of the complementary cavity, according to the implementation of the present disclosure illustrated in FIG. 6.

FIG. 33 is a sectional view of a shaft with its support, placed over the mold, under a cap forming with the mold a pressurized closed space on either side of the rim of the cavity of the mold, with a pressurization channel of the cavity and of the complementary cavity, according to the implementation of the present disclosure illustrated in FIG. 6.

FIG. 34 is a sectional view of a shaft with its support, placed over the mold, under a cap forming with the mold a pressurized closed space on either side of the rim of the cavity of the mold, with several pressurization channels of the cavity matching with the through holes of an insert placed at the level of the outer sole, according to the implementation of the present disclosure illustrated in FIG. 6.

### DETAILED DESCRIPTION

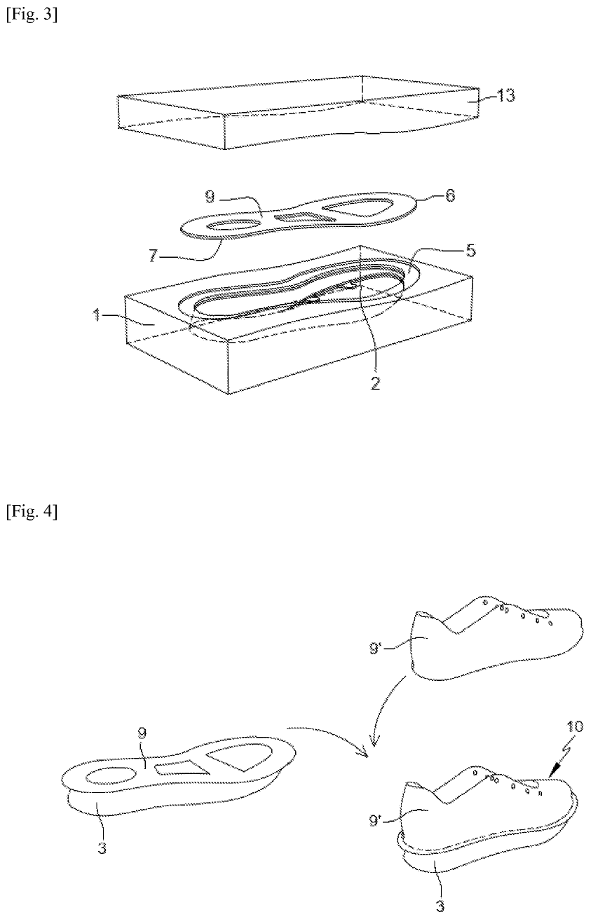

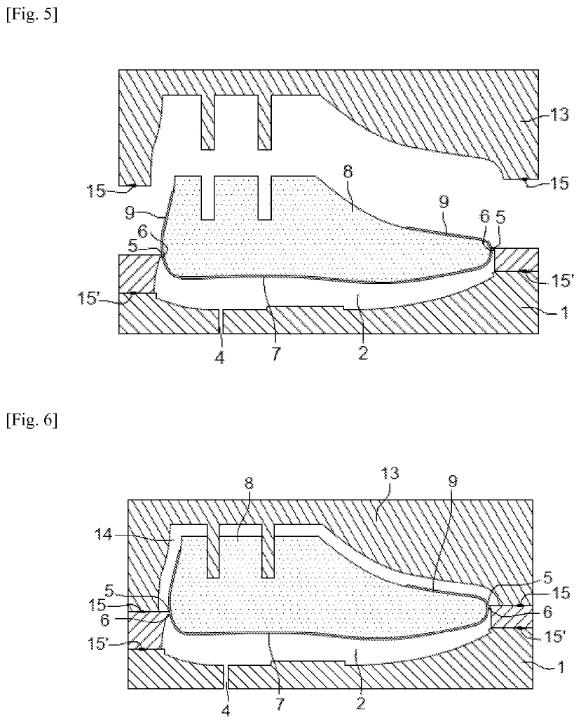

Referring to FIG. 19, the present disclosure relates to a method 100 for manufacturing at least one portion of a footwear, for example a shoe 10, represented in FIG. 4 or 8, using a step of injecting 107, in a cavity 2 of a mold 1, a supercritical mixture comprising a molten thermoplastic material and a gas in a supercritical state, so as to make the thermoplastic material foam in order to obtain satisfactory properties of a foamed material which forms a light and damping sole 3 of the shoe 10; in particular, FIG. 4 or 8 show the portion of the shoe 10 obtained upon completion of the method 100, with the portion 9 of the shaft embedded in the foamed material of the sole 3. To obtain this result, the cavity 2 has at least partially a shape corresponding to the final shape of the sole 3 made of foam to be obtained; this is illustrated in particular in FIGS. 3 and 5. For example, the dimensions of the shape of the cavity are the dimensions at a scale comprised between 1:0.98 and 1:1.02, and advantageously 1 for 1, of the shape of the sole of the footwear.

In order to make the molten thermoplastic material foam to obtain the foamed material which forms the sole 3, the method consists in pressurizing the cavity 2 of the mold 1, in particular by injection of a gas in the cavity 2, before injecting the supercritical mixture in the cavity 2, then depressurizing the cavity 2 in order to trigger an expansion and a foaming of the thermoplastic mixture in the cavity 2 in order to obtain the foamed material of the sole 3.

For a portion 9 of the shaft of the shoe 10 to be embedded in the foamed material of the sole 3, the portion 9 of the shaft is placed in an appropriate manner in the cavity 2 of the mold; to this end, as illustrated in FIGS. 3 and 5, the cavity 2 comprises an opening with a rim 5 on which an area 6 is placed, called docking area 6, of a surface 7 of the portion of the shaft 9, so that the surface 7 of the portion of the shaft 9 ensures closure of the cavity at the level of the contact between the docking area 6 and the rim 5.

In order to be able to pressurize the cavity 2 of the mold 1, in particular by injection of a gas in the cavity 2, it is then essential to ensure a sufficient sealing in particular gas-tightness of the closure of the cavity 2 at the level of the contact between the docking area 6 and the rim 5; the thickness of the shaft being variable, the shaft may take on complex shapes, with large dimensional tolerances, it may be difficulty to obtain the desired sealing. A particularly advantageous solution may be the use of a counter-pressure in the area of the shaft 9 that is not immersed in the cavity 2, i.e. in the area of the shaft that is on the other side of the closure with respect to the cavity 2. In FIG. 5 in particular, the area of the shaft 9 which is immersed in the cavity 2 lies in the lower part of the figure, and the portion of the shaft 9 that is not immersed in the cavity lies above the line joining the two points of the docking area 6, bearing the references 5, 6 in FIGS. 5 and 6.

Thus, when the pressurization of the cavity 2 is accompanied with the simultaneous creation of a counter-pressure, advantageously identical to the pressurization pressure of the cavity 2, in the area of the shaft 9 that is not immersed in the cavity 2, i.e. in the area of the shaft that is on the other side of the closure with respect to the cavity 2, the counter-pressure allows avoiding leakages, at the level of the contact between the docking area and the rim, of the pressurization gas of the cavity.

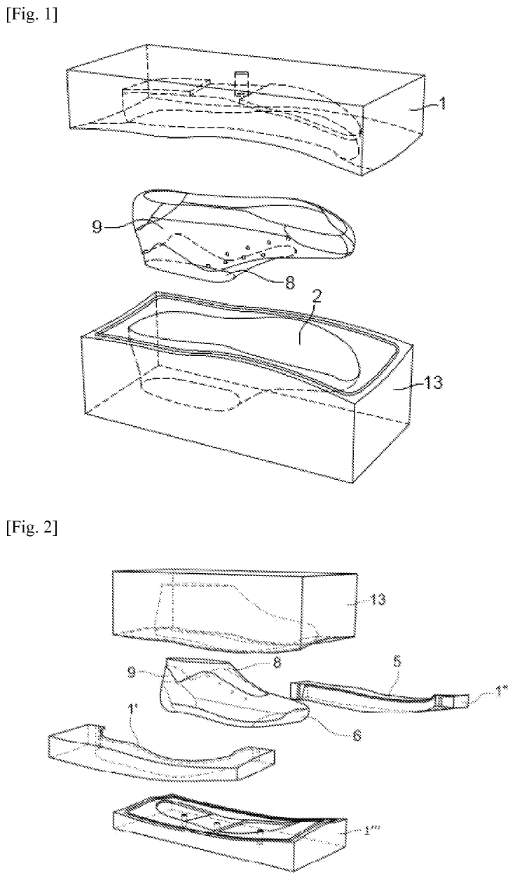

To create the counter-pressure, before the step of injecting 107 the supercritical mixture in the cavity 2 of the mold 1, the method 100 comprises, for example, a step of placing 103bis a cap 13 over the mold 1 so as to form with the mold 1 a closed volume comprising the cavity 2, and a complementary portion 14 of the cavity 2 in the closed volume, the complementary portion 14 and the cavity 2 lying on either side of the closure of the cavity 2 at the level of the contact between the docking rea 6 and the rim 5. In particular, FIG. 6 shows the cap 13 set over the mold 1, in order to form the closed volume comprising the cavity 2 on the one hand and the complementary volume 14 on the other hand; the surface 7 of the portion of the shaft 9 intended to be embedded in the foamed material of the sole 3 lies inside the cavity 2 of the mold 1, and the surface of the other portion of the shaft lies inside the complementary portion 14 of the cavity 2 in the closed volume formed by the cap 13 placed over the mold 1. In FIG. 5, in particular, the cap 13 of the mold 1 is represented above the mold corresponding thereto, but a person skilled in the art should understand that the method also functions with a mold 1 above the cap 13 as illustrated as example in FIG. 1 in perspective. As illustrated in FIGS. 5 and 6, seals 15 may also be placed at the level of a contact area between the cap 13 and the mold 1 to ensure proper sealing of the closed volume constituted of the cap 13 and the mold 1.

Complementary portion 14 is pressurized, for example by injection of a gas in the complementary portion 14 at a pressure similar to the pressure of the cavity 2 so that the sealing defects at the level of the area 6 and the rim 5 do not create any leakage of a pressurization gas between the cavity 2 and the complementary portion 14, the pressure in the complementary portion 14 serving as a counter-pressure opposing the pressure in the cavity 2. The injection 107 of the supercritical mixture in the cavity 2 could then take place, for example via an injection channel 4 crossing the mold 1, as illustrated in FIG. 6.

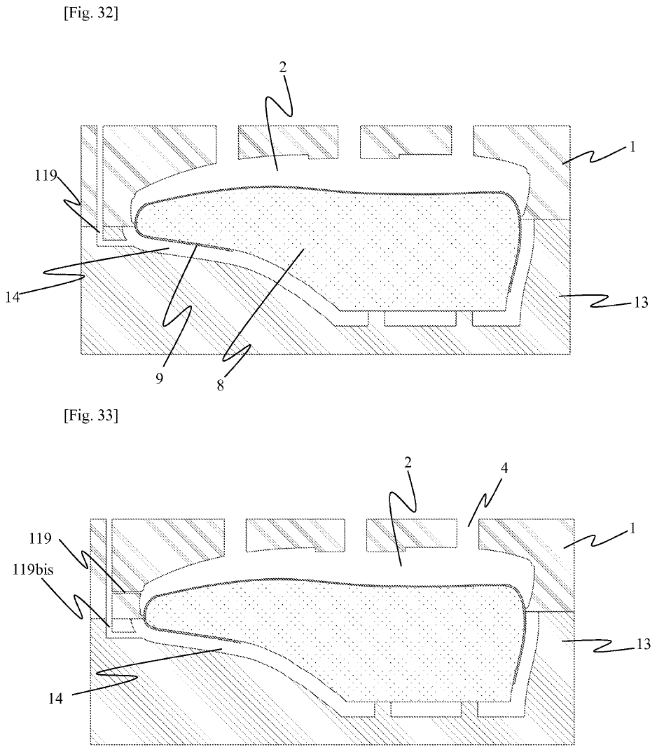

The injection of the pressurization gas is carried out via one or several pressurization channel(s) 119, 119bis, distinct from the injection channel(s) 4 of the mixture, as illustrated in FIGS. 32 and 33. In particular, a pressurization channel 119 may be used for pressurization of the cavity 2, and a complementary pressurization channel 119bis may be used for pressurization of the complementary cavity 14, as illustrated in FIG. 33.

According to an exemplary implementation, the cap 13 is configured to form with the mold 1 a sealed closed volume, in particular gastight, around the at least one portion of the shaft 9, so as to enable the creation of the counter-pressure inside this sealed closed volume, in particular by receiving the pressurization gas of the cavity 2 in this sealed volume, in order to avoid leakages, at the level of the contact between the docking area and the rim, of a pressurization gas of the cavity.

Advantageously, the area of the at least one portion of the shaft 9 on the other side of the closure with respect to the cavity 2 may be depressurized simultaneously with the depressurization of the cavity 2 of the mold 1 to trigger an expansion of the mixture in the cavity 2 and form the sole over the method 100 according to the present disclosure.

For example, a pressurization pressure of the cavity is comprised between 3 bars and 50 bars, preferably between 10 bars and 30 bars, preferably equal to 15 bars.

Referring to FIG. 19, we describe the complete progress of the steps of the method 100 for manufacturing a shoe 10, according to an embodiment which therefore comprises the following steps:
providing 103 a mold 1 defining an open cavity 2, a shape of at least one portion of the cavity 2 corresponding to a shape of a sole 3 of the shoe 10, the cavity 2 being configured to receive, via at least one injection channel 4 opening into the cavity 2, a mixture comprising a molten material and a supercritical fluid;
placing 105 a rim 5 of an opening of the open cavity 2 in contact with a docking area 6 of a surface 7 of at least one portion of a shaft 9 of the shoe 10, so that the surface 7 of the at least one portion of the shaft 9 ensures closure of the cavity at the level of the contact between the docking area 6 and the rim 5;
pressurizing 105bis the cavity 2, in particular by injection of a gas in the cavity 2;
injecting 107 the mixture in the cavity 2;
depressurizing 108 the cavity 2 of the mold, in particular by evacuation of the gas from the cavity 2, to trigger an expansion of the mixture in the cavity 2 and form the sole 3 in a foamed material resulting from the expansion of the mixture, the at least one portion of the surface 7 of the at least one portion 9 of the shaft being embedded in the foamed material of the sole 3.

According to these arrangements, the method allows obtaining, in one single injection step 107, a light and damping sole of the shoe 10 connected to a portion of a shaft 9 of the shoe 10, with a good delamination resistance of the sole 3 and of the shaft 9.

A pressurization in the cavity 2 followed by a depressurization in the cavity 2 enables an expansion of the mixture and the obtainment of the light and damping foamed material of the sole. A pressurization pressure in the complementary portion 14 of the closed volume allows ensuring sealing, in particular gas-tightness, of the closure of the cavity 2, at the level of the contact between the docking area 6 and the rim 5.

For example, the molten material is an elastomer thermoplastic polymer.

According to an exemplary implementation, the thermoplastic polymer is a thermoplastic polyurethane (TPU), or an ether-amide block copolymer (PEBA), or an ethylene-vinyl acetate (EVA), or a polyolefin, or an ether-ester block copolymer, or a styrene-based elastomer, or a mixture of these different components.

For example, the supercritical fluid is nitrogen in a supercritical state or carbonic gas in a supercritical state or a mixture of nitrogen and carbonic gas in a supercritical state.

The density of the sole 3 obtained at the end is comprised between 0.1 g/cm3 and 0.4 g/cm3, preferably between 0.15 g/cm3 and 0.25 g/cm3.

Furthermore, the portion of the shaft 9 embedded in the foamed material of the sole 3 allows obtaining a delamination resistance higher than 2.5 N/mm, measured according to the standard ISO NF EN 1392.

In particular, step 105bis of pressurizing the cavity 2 may, for example, comprise the following step:
placing 103bis a cap 13 over the mold 1 so as to form with the mold 1 a closed volume comprising the cavity 2, and a complementary portion 14 of the cavity 2 in the closed volume, the at least one portion of the shaft 9 lying inside the closed volume, the complementary portion 14 and the cavity 2 lying on either side of the closure of the cavity 2 at the level of the contact between the docking area 6 and the rim 5.

A pressurization pressure in the complementary portion 14 of the closed volume allows avoiding leakages, at the level of the contact between the docking area 6 and the rim 5, of a pressurization gas of the cavity 2.

According to an exemplary implementation, illustrated in FIG. 3, the portion 9 of the shaft is placed directly on the rim 5 of the opening of the cavity 2 of the mold 1, without using a support 8 to hold the shaft.

In particular, the method may comprise a complementary step of assembling the portion of the shaft 9 linked to the sole 3 obtained after the depressurization step, with another portion 9′ of the shaft, the assembly forming the shoe 10, as illustrated in FIG. 4. For example, the assembling step may comprise a stitch of the other portion 9′ of the shaft with the portion of the shaft 9 connected to the sole 3.

According to another exemplary implementation, illustrated in FIGS. 5 and 6, the portion 9 of the shaft is first placed over a support 8 so as to cover 102 at least partially an outer surface of the support 8, the support 8 having a shape corresponding to a shape of a foot; a portion of the surface 7 of the portion of the shaft 9, intended to be embedded in the foamed material of the sole 3, covers a portion of the outer surface of the support 8 corresponding to a sole of the foot. During the step of placing 105 the portion of the shaft 9 on the rim 5 of the cavity 2, the portion of the shaft 9 is thus placed, with the support 8, on the rim 5 of the cavity 2, so that after placing 103bis the cap 13 over the mold 1, the closed volume further comprises the support 8 with the portion of the shaft 9; the surface 7 of the portion of the shaft 9 intended to be embedded in the foamed material of the sole 3 lies inside the cavity 2 of the mold 1, with a corresponding portion of the support 8, and the surface of the other portion of the shaft 9, with another corresponding portion of the support 8, lies inside the complementary portion 14 of the cavity 2 in the closed volume formed by the cap 13 placed over the mold 1.

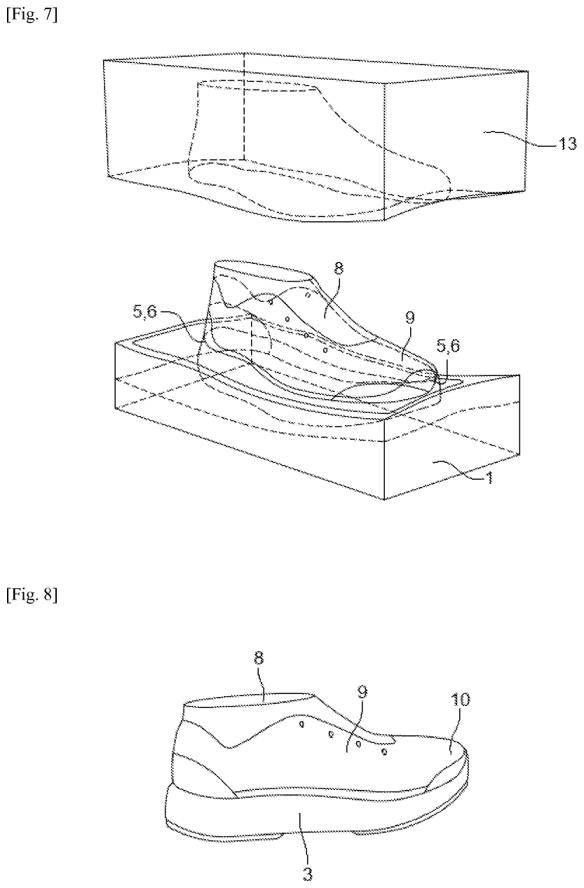

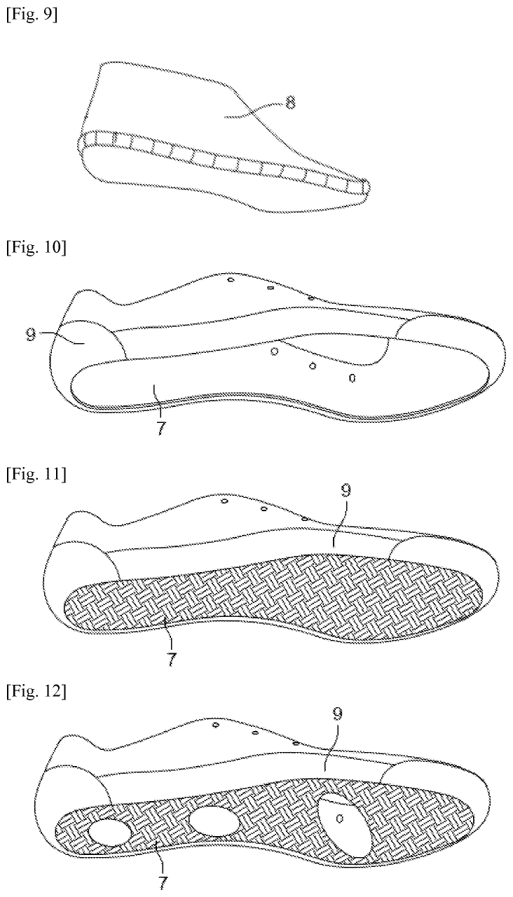

For example, the shaft 9 may be a complete shaft, as illustrated for example in FIG. 7.

For example, the support 8 may be made of aluminum, steel, or plastic.

Thus, the method 100 allows obtaining, in one single injection step 107 a complete shoe 10 comprising a sole 3 of the shoe connected to a complete shaft 9 of the shoe 10, as illustrated in FIG. 8.

The mold 1 is made in one piece, or the mold 1 comprises several portions 1′, 1″, 1′″, as illustrated in FIG. 2, and the step of providing 103 the mold 1 comprises a step of assembling the different portions 1′, 1″, 1′″ to form the mold 1. For example, the mold made in several portions 1′, 1″, 1′″ may comprise a mold bottom 1′″, and two halves 1′, 1″ of a ring-like portion of the mold, as illustrated in FIG. 2; the two halves 1′, 1″ are configured to form a ring when they are assembled, the ring being configured to form the rim 5 of the cavity 2 when it is set on the mold 1 bottom 1″, the rim 5 then being configured to receive the docking area 6 of the portion of the shaft 9. Furthermore, as illustrated in FIGS. 5 and 6, one or several seal(s) 15′ may also be placed at the level of a contact area between the different portions 1′, 1″, 1′″ of the mold to ensure a suitable sealing of the mold 1.

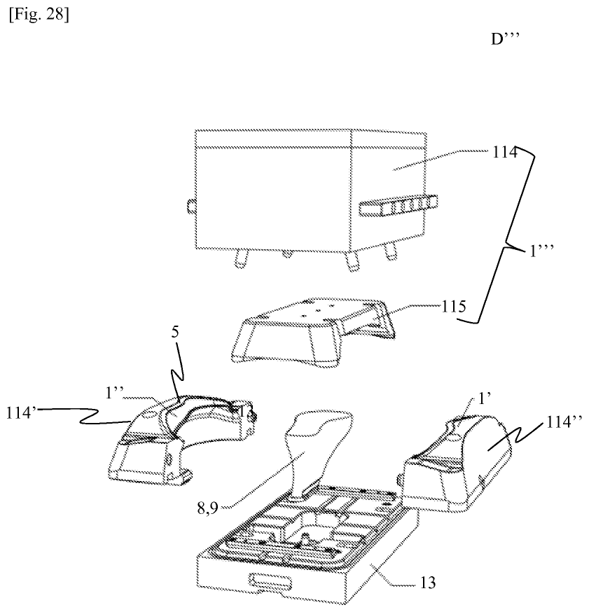

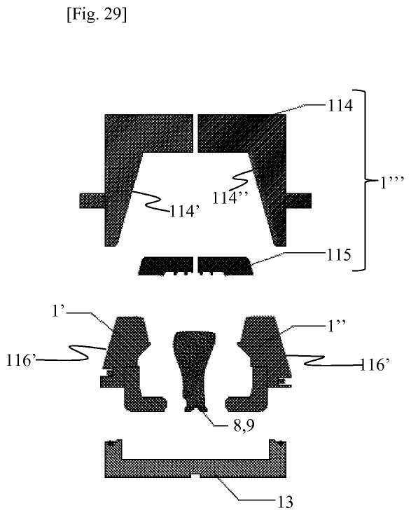

According to an embodiment of the mold, illustrated in FIGS. 28 to 31, the mold comprises a mold bottom 1″ and two halves 1′, 1″ of a ring-like portion of the mold, similarly to the mold of FIG. 2; it should be noted that in FIG. 28, the mold bottom 1′″ is above the two halves 1′ and 1″ of the ring-like portion, while in FIG. 2, the mold bottom is below; a person skilled in the art should understand that this difference in the representation is not significant. Like in FIG. 2, the two halves 1′ and 1″ of the ring-like portion are configured to form a ring when they are assembled, the ring being configured to form the rim 5 of the cavity 2 when it is set on the mold bottom 1′″, the rim 5 then being configured to receive the docking area 6 of the portion of the shaft 9.

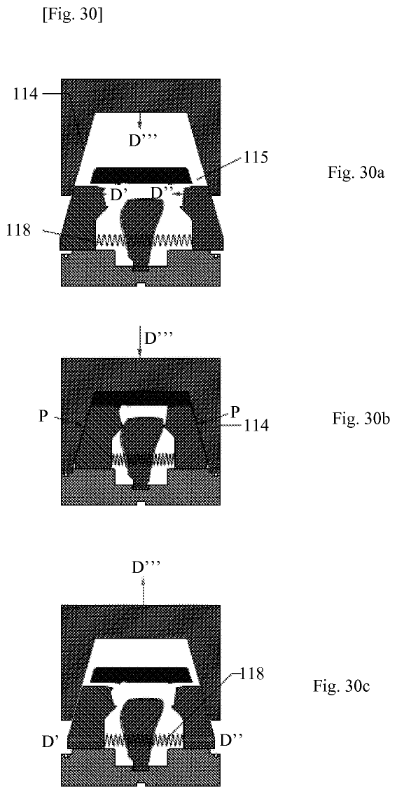

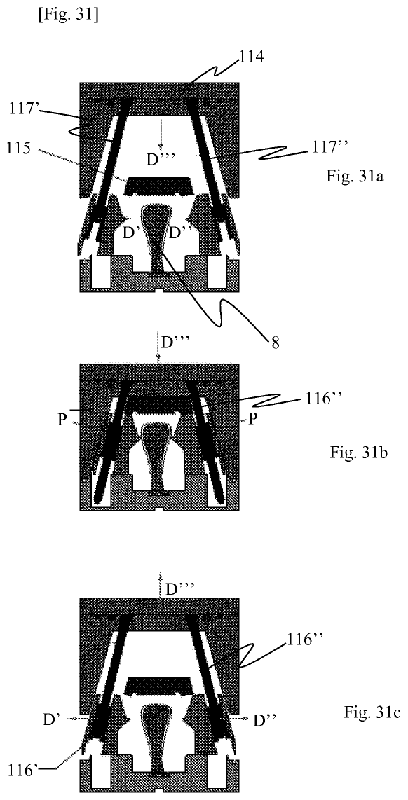

According to the particular embodiment of FIG. 28, the mold bottom 1′″ comprises two distinct portions, on the one hand a cover 115, on the other hand a bell 114, the bell 114 being configured to enclose all of the portions comprising the cover 115 and the two halves 1′, 1″ of the ring-like portion, when the mold is closed; More particularly, the two halves 1′, 1″ of the ring-like portion of the mold are configured to be mechanically actuated so as to be displaced relative to one another, by sliding according to a sliding direction, a first half 1′ being displaced according to a way D′ of the sliding direction, and the second half 1″ being displaced according to an opposite way D″ of the sliding direction, so that the two halves 1′, 1″ of the ring being separated from one another as illustrated in FIG. 30c or 31c, or approaching each other as illustrated in FIG. 30a or 31a, according to the sliding displacement of the two halves being done in a first way, illustrated in FIG. 30c or 31c, or in a second way illustrated in FIG. 30a or 31a; thus the ring of the mold is closed when the two halves 1′, 1″ are actuated so as to approach each other, and conversely the ring of the mold opens when the two halves 1′, 1″ are actuated so as to separate from each other.

Even more particularly, a contact interface between the bell 114 of the mold bottom 1′″ and each of the two halves 1′, 1″ of the ring is configured so that the sliding displacement of the two halves in the way of separation of the two halves 1′, 1″ of the ring actuates a displacement of the bell 114 of the mold bottom 1′″ in a direction D″ transverse to the sliding direction, so that the bell 114, initially in contact with the closed ring formed by its two halves 1′, 1″ close to each other, moves away from the ring when its two halves 1′, 1″ move away from each other. Conversely, when the bell 114 of the mold bottom 1′″ is pushed so as to approach the two halves 1′, 1″ of the ring according to the direction D″ transverse to the sliding direction, the pressure P exerted by the bell 114 on the two halves 1′, 1″ at the level of the contact interface, as illustrated in FIGS. 30b and 31b, actuates a sliding displacement of the two halves 1′, 1″ of the ring move away from each other when the bell 114 of the mold bottom 1′″ is displaced so as to move away from the ring in the direction D′″ transverse to the sliding direction.

To this end, as illustrated in FIGS. 28 to 30, the contact interface between the bell 114 of the mold bottom 1′″ and each of the two halves 1′, 1″ of the ring, comprises a contact plane 114′ between the bell 114 of the mold bottom 1′″ and the first half 1′ of the ring, the first contact plane 114′ being inclined with respect to the sliding direction according to a first angle, and a second contact plane 114″ between the bell 114 of the mold bottom 1′″ and the second half 1″ of the ring, the second contact plane 114″ being inclined with respect to the sliding direction according to a second angle, the second angle having a sign opposite to the first angle. The first contact plane 114′ is configured to slip on contact with a corresponding first contact surface 116′ of a wall of the first half 1′ of the ring, and the second contact plane 114″ is configured to slip on contact with a corresponding second contact surface 116′ of a wall of the second half 1″ of the ring.

According to a variant of the embodiment illustrated in FIGS. 28 to 30, the variant being illustrated in FIG. 31, the contact interface between the bell 114 of the mold bottom 1′″ and each of the two halves 1′, 1″ of the ring, comprises at least one guide 117′, 117″ configured to accompany the sliding displacement of the two portions 1′ and 1″ of the ring when the bell 114 of the mold bottom 1′″ is displaced in the direction transverse to the sliding direction.

According to these arrangements, the mold may be alternately actuated, so as to be closed, through a displacement of the mold bottom 1′″ in the direction D′″ transverse to the sliding direction, and to be open, through a sliding displacement of the two halves 1′, 1″ so as to open the ring. The displacement of the mold bottom 1′″ for closure may be obtained, for example, by a pressure exerted on the mold bottom 1′″ towards the ring; a sliding displacement of the two halves 1′, 1″ for opening may be obtained, for example, by an elastic device.

To enable the implementation of the injection step 107, the cavity 2 of the mold is configured to receive, via at least one injection channel 4, 4′, 4″, 4′″ opening into the cavity 2, the mixture comprising a molten material and a supercritical fluid.

For example, the mold may comprise an injection channel 4 opening into the cavity 2, as illustrated in FIG. 6. According to another example, the injection channel 4 opening into the cavity 2 may cross the support 8 of the shaft 9, as illustrated in FIG. 15.

According to still another example, the cavity 2 is configured to receive the mixture via at least two injection channels 4′, 4″, 4′″ opening into the cavity 2, as illustrated in FIG. 14 wherein 3 injection channels 4′, 4″, 4′″ are represented as example. Thus, the method 100 allows obtaining, more rapidly and with a more homogeneous filling of the cavity of the mold, a sole 3 of the shoe 10 linked to a portion of the shaft 9 of the shoe 10.

To improve the solidity of the connection between the shaft 9 and the sole 3, it is particularly possible to provide for a complementary step of gluing 106 the portion of the surface 7 of the portion of the shaft 9, the gluing step 106 being carried out before the injection step 107. Alternatively, or in combination with the gluing step 106, the portion of the surface 7 of the portion of the shaft 9 may comprise hot-melt wires configured to melt down at an injection temperature of the mixture. Thus, the delamination resistance of the sole and of the shaft is enhanced.

According to an exemplary implementation of the method, the portion of the surface 7 of the portion of the shaft 9, intended to be embedded in the foamed material of the sole 3, is solid as illustrated in FIG. 11. To enhance the delamination resistance, it is also possible to provide for the portion of the surface 7 of the portion of the shaft 9, intended to be embedded in the foamed material of the sole 3, is apertured, i.e. the portion of the surface 7 includes holes as illustrated in FIG. 12 or in FIG. 3, for example with 3 holes crossing the portion of the surface 7 of the portion of the shaft 9; it is also possible to provide for the portion of the surface 7 to be at least partially open as illustrated in FIG. 10, for example with the portion of the surface 7 almost totally open except over a portion of this surface 7 proximate to the docking area 6. In the case represented in FIG. 3, wherein 3 holes cross the portion of the surface 7 of the portion of the shaft 9, and wherein the portion of the shaft 9 intended to be embedded in the foamed material of the sole 3 is not placed over a support 8, the cap 13 should ensure closure of the holes or openings of the portion of the surface 7 of the portion of the shaft 9 during step 105bis of pressurizing the cavity 2 and injecting 107 the mixture in the cavity. To this end, the cap 13 could, for example as illustrated in FIG. 3, bear, for example with a substantially flat and planar internal surface, on the portion of the surface 7 of the portion of the shaft 9 so as to close the holes or the openings present over this portion of the surface 7 of the portion of the shaft 9.

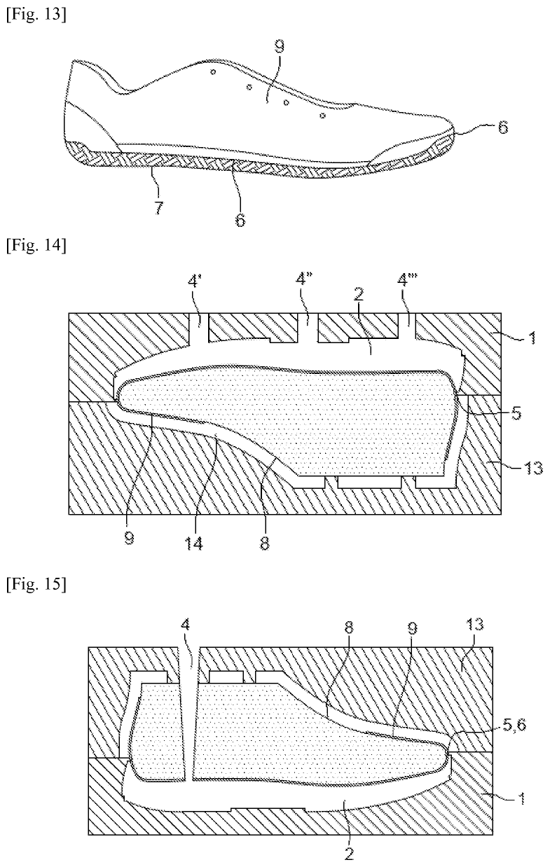

Still another manner for enhancing the delamination resistance consists in providing for the portion of the surface 7 of the portion of the shaft 9, intended to be embedded in the foamed material of the sole 3, to be textured or punctured on contact or proximity with the docking area 6, as illustrated in FIG. 13.

In order to improve a resistance to abrasion of the sole 3, or a rigidity of the sole 3, the method 100 may comprise the complementary steps of providing 104 and positioning 104bis one or several insert(s) 12, 12′, 12″ configured to be positioned in the cavity 2 of the mold 1.

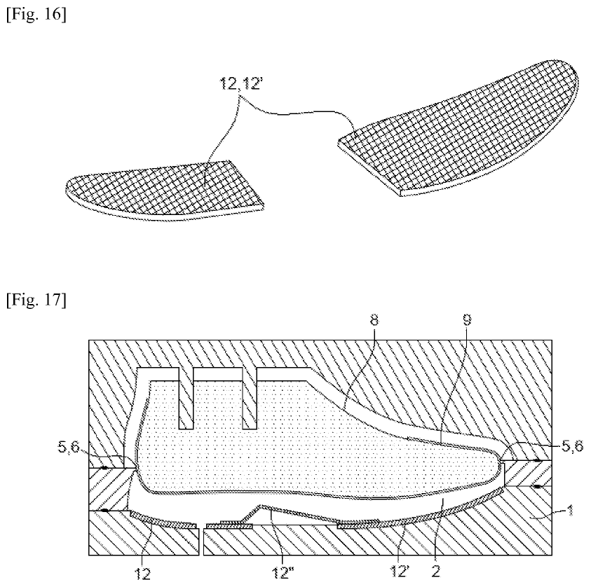

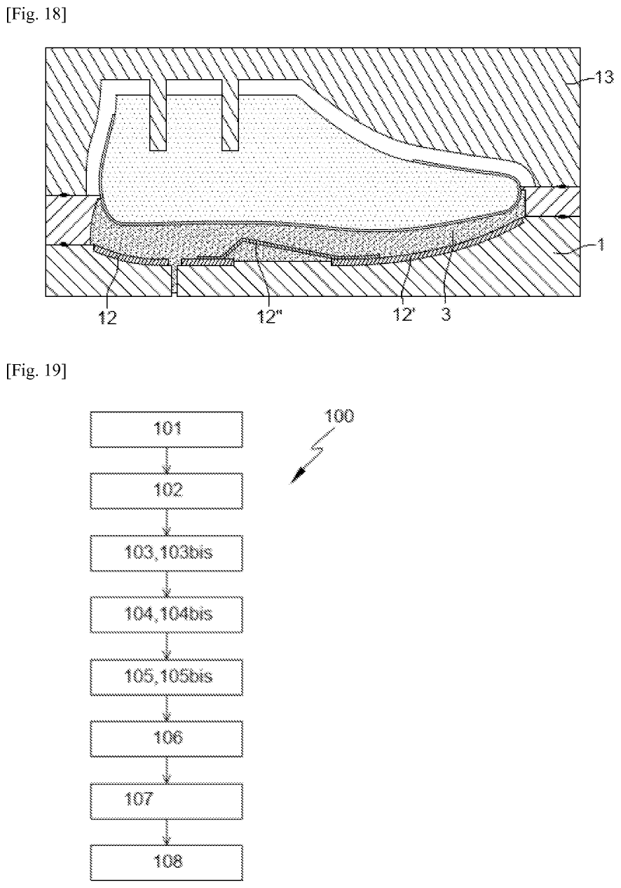

For example, the insert(s) 12, 12′ represented in FIG. 16 are positioned so as to fit at the level of an outer surface of the sole, as illustrated respectively before and after the step of injecting 107 the mixture in the cavity 2 in FIGS. 17 and 18; according to another example, an insert or several inserts 12″ may be positioned so as to be buried inside the sole 3, as illustrated respectively before and after the step of injecting 107 the mixture in the cavity 2 in FIGS. 17 and 18.

According to these arrangements, the resistance to abrasion of the sole is enhanced, or a rigidity of the sole is improved, respectively depending on whether the inserts 12, 12′ are inserted towards an outer portion of the sole 3, for example with inserts 12, 12′ made of rubber or a thermoplastic material, or the insert or the inserts 12″ is/are buried inside the sole 3, for example with inserts 12″ made of carbon board or of a thermoplastic material.

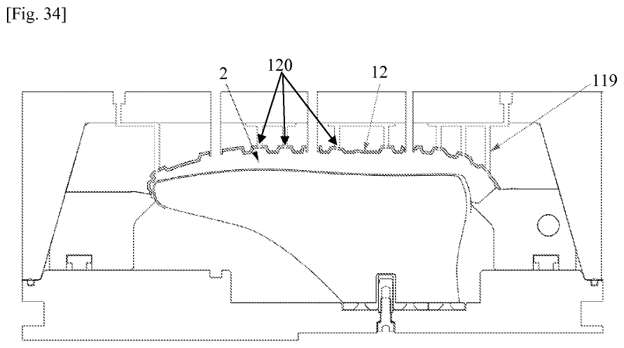

According to one implementation, an insert 12″ is positioned so as to be inserted at the level of an outer surface of the sole 3 comprises one or several through hole(s) 120, the through hole(s) 120 being matched with one or several pressurization channel(s) 119, as illustrated in FIG. 34, so that a pressurization gas could pass through the insert.

According to an exemplary implementation, a contact surface 112 between the insert and the sole has a particular geometry, in order to enhance, by mechanical hooking, the adhesion between the insert and the sole, while doing without the steps of gluing or preparing surfaces. For example, the particular geometry of the insert comprises a texture of the contact surface, as illustrated in FIG. 25, 26 or 27.

For example, the texture comprises a plurality of patterns formed over the contact surface 112, the plurality of patterns being distributed over the surface, according to a determined density, so that over a portion of the contact surface, the plurality of patterns occupies part of the portion of the contact surface, the portion being comprised between 1% and 15% advantageously 6%, of the portion of the contact surface.

Preferably, the patterns are homogeneously distributed over the contact surface, according to the determined density. The distribution of the patterns may also be densified in some areas of the contact surface for which the loads are stronger. In other words, the distribution density of the patterns over an area of the contact surface may depend on the loads to which the considered area is subjected.

The patterns have a height, measured according to a direction of the height transverse to the contact surface, the height being comprised between 1 mm and 10 mm, preferably equal to 1.6 mm.

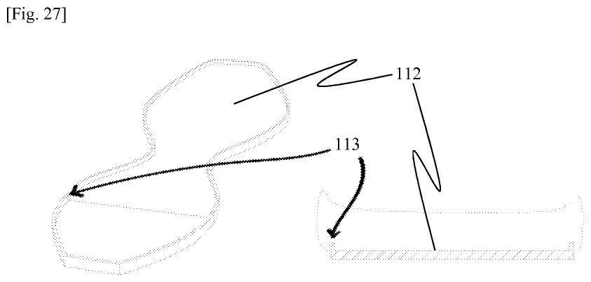

The patterns have a thickness, measured according to a direction transverse to the direction of the height; the thickness being comprised between 1 mm and 2 mm, preferably equal to 1.6 mm. The thickness is a diameter, respectively a width, depending on whether the patterns are tubular or cylindrical as illustrated in FIG. 25, respectively linear as illustrated in FIG. 26.

The texture may comprise tubular or cylindrical patterns at the center of the contact surface and a linear pattern over a contour 113 of the contact surface, as illustrated in FIG. 27, in order to avoid delamination start spots.

The linear pattern over the contour may be a burr obtained on a mating plane of a closure of a mold for overmolding the insert, which allows avoiding eliminating the burr.

According to one aspect, the present disclosure also covers a footwear, for example a shoe 10 obtained by the method 100 according to one of the previously-described implementations.

According to another aspect, the present disclosure also covers a device comprising a mold 1, and possibly a cap 13, and possibly a support 8, configured to implement the method 100 according to one of the previously-described implementations.

According to one embodiment, the device comprises a mold 1 defining an open cavity 2, a shape of at least one portion of the cavity 2 corresponding to a shape of a sole 3 of the shoe 10, the cavity 2 being configured to receive, via at least one injection channel 4, 4′, 4″, 4′″ opening into the cavity 2, a mixture comprising a molten material and a supercritical fluid, a rim 5 of an opening of the open cavity 2 being configured to be placed in contact with a docking area 6 of a surface 7 of at least one portion of a shaft 9 of the shoe 10, so that the surface 7 of the at least one portion of the shaft 9 ensures closure of the cavity at the level of the contact between the docking area 6 and the rim 5, so that the device is thus configured to implement the manufacturing method 100 according to one of the previously-described implementations.

According to a complementary embodiment, the device further comprises a cap 13 configured to be placed over the mold 1 so as to form with the mold a closed volume comprising the cavity 2, and a complementary portion 14 of the cavity in the closed volume, the at least one portion of the shaft 9 of the shoe lying inside the closed volume, the complementary portion 14 and the cavity 2 lying on either side of the closure of the cavity 2 at the level of the contact between the docking area 6 and the rim 5, the device being thus configured to implement the manufacturing method 100, according to one of the previously-described implementations.

According to another complementary embodiment, the device further comprises a support 8 having a shape corresponding to a shape of a foot, an outer surface of the support 8 being configured to be covered with the at least one portion of the shaft 9 of the shoe, the at least one portion of the surface 7 of the at least one portion of the shaft 9 covering a portion of the outer surface of the support corresponding to a sole of the foot.

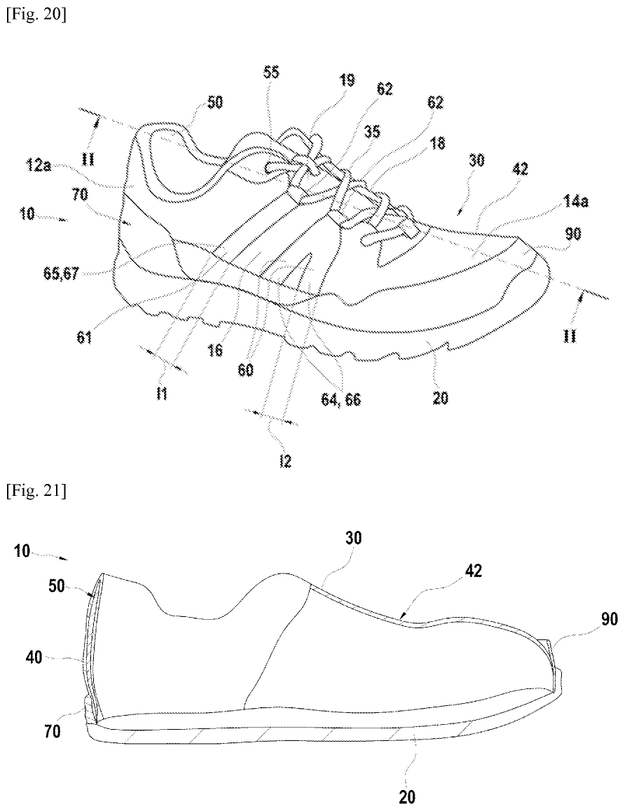

According to one embodiment, the shoe 10 represented in FIG. 20 comprises a sole obtained by the previously-described method 100; most of the mass of the sole is made of a sole main material; in other words the foamed material, resulting from the expansion of the mixture implemented in the method 100, comprises the sole main material; the shoe 10 further comprises a shaft 30 most of the mass of which is made of a shaft main material.

The sole main material may be selected from among polyolefins, styrenic thermoplastic elastomers, olefinic thermoplastic elastomers, vulcanized thermoplastic elastomers, thermoplastic polyurethanes (TPU), polyamides, an ether-amide block copolymer (PEBA), an ethylene-vinyl acetate (EVA), an ether-ester block copolymer, a styrene-based elastomer, and a polyester.

For example, the sole main material is a styrenic thermoplastic elastomer, selected in particular from among SEBS (possibly grafted), SBS, SBC, SIS, and SEPS, in this specific example SEBS.

Advantageously, the sole main material is selected from among polyesters, thermoplastic polyurethanes (TPU), polyolefins, and block copolymers composed of rigid polyamide blocks and soft polyether blocks (and in particular the compound commercialized under the name Pebax® by the Arkema company).

The sole 20 may comprise a first sole auxiliary material, in particular a polyolefin, more particularly it consists of polypropylene, the foamed material, resulting from the expansion of the mixture, comprising the sole main material and the first sole auxiliary material.

The sole main material may be selected from among polyolefins, styrenic thermoplastic elastomers, olefinic thermoplastic elastomers, vulcanized thermoplastic elastomers, thermoplastic polyurethanes (TPU), polyamides, an ether-amide block copolymer (PEBA), an ethylene-vinyl acetate (EVA), an ether-ester block copolymer, a styrene-based elastomer, and a polyester; and for example a polyolefin, in particular polyethylene or polypropylene, in this specific example polypropylene.

Advantageously, the shaft main material is selected from among polyesters, thermoplastic polyurethanes (TPU), polyolefins, and block copolymers composed of rigid polyamide blocks and soft polyether blocks (and in particular the compound commercialized under the name Pebax® by the Arkema company).

Advantageously, the shaft 30 comprises a lace 35 made of polypropylene, in particular comprising braided wires made of polypropylene.

Advantageously, the shaft 30 comprises a component 40 folded on itself and comprising a laminated foam over both faces thereof with a textile selected in particular from among polyolefins, styrenic thermoplastic elastomers, olefinic thermoplastic elastomers, vulcanized thermoplastic elastomers, thermoplastic polyurethanes (TPU), polyamides, an ether-amide block copolymer (PEBA), an ethylene-vinyl acetate (EVA), an ether-ester block copolymer, a styrene-based elastomer, and a polyester. Preferably, the textiles are made of polypropylene and/or polyethylene, in particular a fabric or a knitting with wires made of polypropylene and/or wires made of polyethelene, preferably wires made of polypropylene. The foam may be selected from among polyolefins, styrenic thermoplastic elastomers, olefinic thermoplastic elastomers, thermoplastic polyurethanes (TPU), polyamides, an ether-amide block copolymer (PEBA), an ethylene-vinyl acetate (EVA), an ether-ester block copolymer, a styrene-based elastomer, and a polyester; for example a foam made of polyethelene.

The shaft 30 may also comprise a component made of foam 50 accommodated in the fold of the outer component 40, preferably made of polyethylene, the foam improves the accommodation of the hindfoot. The foam may be selected from among polyolefins, styrenic thermoplastic elastomers, olefinic thermoplastic elastomers, thermoplastic polyurethanes (TPU), polyamides, an ether-amide block copolymer (PEBA), an ethylene-vinyl acetate (EVA), an ether-ester block copolymer, a styrene-based elastomer, and a polyester.

The edges of the component 40 folded on itself may be secured according to any technique known to a person skilled in the art, for example using one or several stitch(es), preferably made with one or more wire(s) made of a material selected from among polyolefins, styrenic thermoplastic elastomers, olefinic thermoplastic elastomers, vulcanized thermoplastic elastomers, thermoplastic polyurethanes (TPU), polyamides, an ether-amide block copolymer (PEBA), an ethylene-vinyl acetate (EVA), an ether-ester block copolymer, a styrene-based elastomer, and a polyester, and in particular one or more wire(s) made of polyolefin, in particular made of polypropylene.

Preferably, the shaft component 40 is arranged in the hindfoot region 12a and partially in the foot medial 18 and lateral 16 regions.

Advantageously, the shaft 30 further comprises the shaft component 42 arranged in the forefoot regions 14a, and partially in the foot lateral 16 and medial 18 regions. The shaft component 42 may comprise a knitting or a fabric. The shaft 30 may comprise other shaft component(s). Preferably, all shaft elements including the components 40 and 42 are three-dimensionally shaped using a first mounting. Preferably, the first mounting comprises a material selected from among polyolefins, styrenic thermoplastic elastomers, olefinic thermoplastic elastomers, vulcanized thermoplastic elastomers, thermoplastic polyurethanes (TPU), polyamides, an ether-amide block copolymer (PEBA), an ethylene-vinyl acetate (EVA), an ether-ester block copolymer, a styrene-based elastomer, and a polyester; for example, a matt made of polyolefin, in particular of polypropylene. Advantageously, the first mounting is heat-molten over all or part of its surface to improve its tear resistance.

The shaft 30 comprises, preferably as well as any shaft according to the present disclosure, a hindfoot region 12a, a forefoot region 14a, a lateral region 16, a medial region 18 and an instep region 19 comprising a tab.

Shaping of the component 40, possibly with other shaft component(s), on a foot-like shaped preform (so-called lasting operation) is performed for example using a bead comprising a material selected from among polyolefins, styrenic thermoplastic elastomers, olefinic thermoplastic elastomers, vulcanized thermoplastic elastomers, thermoplastic polyurethanes (TPU), polyamides, an ether-amide block copolymer (PEBA), an ethylene-vinyl acetate (EVA), an ether-ester block copolymer, a styrene-based elastomer, and a polyester; and in particular a bead made of polypropylene (for example a circular braid which is not represented) tensioning the lower edges of the textile component 40 and possibly of the other shaft component(s).

The shoe 10 may also comprise lacing loops 55 made of the molded shaft main material, for example lacing loops 55 made of polypropylene.

The shoe 10 may also comprise a matt made of polypropylene or of polyethylene totally or partially coated with a coating made of poly(ethylene-vinyl acetate) (EVA) allowing securing the lacing loops 55 to the outer textile component 50 by gluing, when the EVA is activated by heating.

The shoe 10 may comprise textile strips 60 and 61, in particular woven, made of polyethylene and/or of polypropylene, in particular comprising wires made of polypropylene and/or wires made of polyethylene, in particular wires made of polypropylene. Each textile strip 60 and 61 comprises a lacing area 62 forming a sheath for the passage of a lace.

Preferably, each of the textile strips 60 and 61 has a width 11 and 12 larger than or equal to 5 mm, in particular larger than or equal to 10 mm, more particularly larger than or equal to 15 mm.

Preferably, the textile strip 60 comprises a first end 64 and a second end 66 secured to the component 40. The first and second ends 64, 66 are spaced apart from each other so that the textile strip 60 forms an inverted V.

Preferably, the textile strip 61 comprises a first end 65 and a second end 67, substantially superimposed, and secured to the component 40.

Preferably, the lacing area 62 comprises a portion folded on itself of the textile strip 60 or 61 and thus forming a sheath for the passage of a lace.

The textile strips 60 and 61 also form lateral reinforcing areas.

The shaft 30 may comprise a rear buttress 70 secured in the hindfoot region 14 of the component 40. Preferably, this rear buttress 70 is a molded part made of polypropylene.

The shaft 30 may also comprise a front hard tip 90 in a molded material, for example in the shaft main material, preferably in a polyolefin, an olefinic thermoplastic elastomer, or a vulcanized thermoplastic elastomer, or a styrenic thermoplastic elastomer, such as SEBS.

For this specific embodiment, the shaft main material of the shaft 30 is a polyolefin, in particular polypropylene. Indeed, this consists of the base thermoplastic material whose mass fraction is predominant, i.e. the greatest compared to the mass fractions of the other materials.

The shaft 30 also comprises a first shaft auxiliary material, different from the shaft main material, which, in this specific example, is polyethylene.

In this specific example, the mass fraction of polyolefin in the shaft is in the range of 55.17%, in particular the mass fraction of polypropylene (shaft main material) in the shaft is in the range of 44.83%, and the mass fraction of polyethylene (first shaft auxiliary material) is in the range of 10.34%. The mass fraction of olefinic thermoplastic elastomer (TPO) in the shaft is in the range of 27.59% (second shaft auxiliary material), and finally the mass fraction of glue is in the range of 17.24%.

The ratio of the mass of the shaft main material 30, in this specific example polypropylene, and of the mass of the shaft auxiliary materials 30, for example of PE and of TPO, relative to the total mass of the shaft 30, is greater than or equal to 80%, in particular in the range of 82% or more if the used glue is EVA. Preferably, this ratio tends towards 100%. When the materials are recycled, one or more contaminant material(s) could subsist whose mass fraction is still low, for example in the range of 5% or less.

The sole 20 could be manufactured at the same time as it is secured to the shaft. In this case, the sole is injected directly over the shaft, i.e. over the lower portion of the shaft 30. Advantageously, the main material of the shaft 30 is compatible with, or made of the same base thermoplastic material as, the sole main material, so that the sole adheres to the shaft, preferably without using any external bonding agent.

Preferably, the mass fraction of the sole main material, in particular SEBS, in the sole is in the range of 65%. The mass fraction of polyolefin, in particular of polypropylene mixed with SEBS, in the sole is in the range of 20%. The mass fraction of the filler (for example of calcium carbonate) in the sole is in the range of 5%. Finally, the mass fraction of the plasticizer in the sole is in the range of 10%.

The shoe 10 essentially comprises a material selected from among polyolefins, styrenic thermoplastic elastomers, olefinic thermoplastic elastomers, vulcanized thermoplastic elastomers, thermoplastic polyurethane (TPU), an ether-amide block copolymer (PEBA), an ethylene-vinyl acetate (EVA), an ether-ester block copolymer, a styrene-based elastomer, and a polyester; and in particular polypropylene, polyethylene, a TPO and SEBS, SEBS being predominant in the sole and the polypropylene being predominant in the shaft. Thus, recycling of the shoe is facilitated since it is not necessary to separate the different components. The shoe is shred and then the shreds are transformed into thermoplastic granules which can be transformed by a conventional thermoplastics shaping technique. Hence, the thermoplastic granules comprise a thermoplastic mixture comprising the materials selected in the present disclosure which are compatible with each other upon hot transformation thereof, and have a good adhesion with each other.

Thus, the thermoplastic granules may advantageously be extruded and injected to manufacture all or part of an outsole or of an intermediate sole.

The thermoplastic granules may also be transformed to manufacture a front hard tip or a rear buttress or lacing loops, a component made of foam or foam beads agglomerated or not.

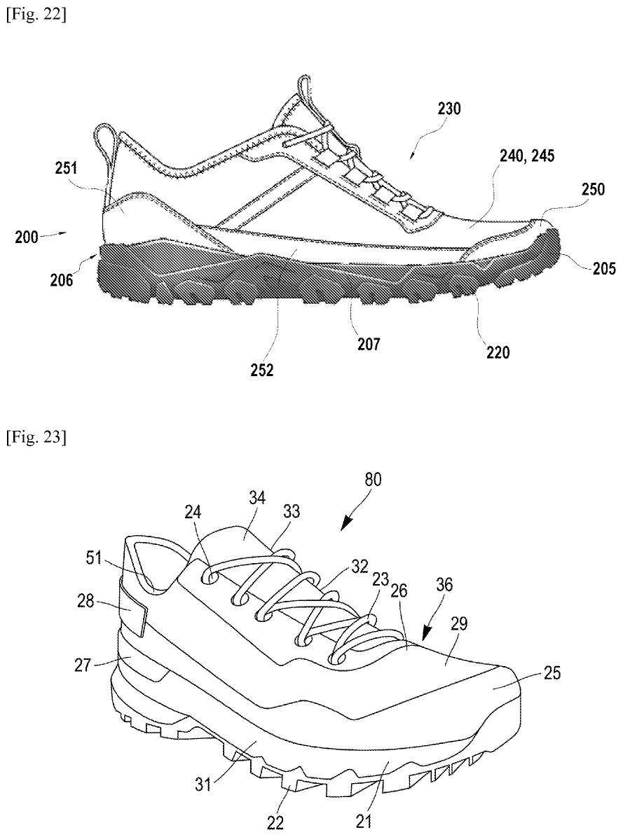

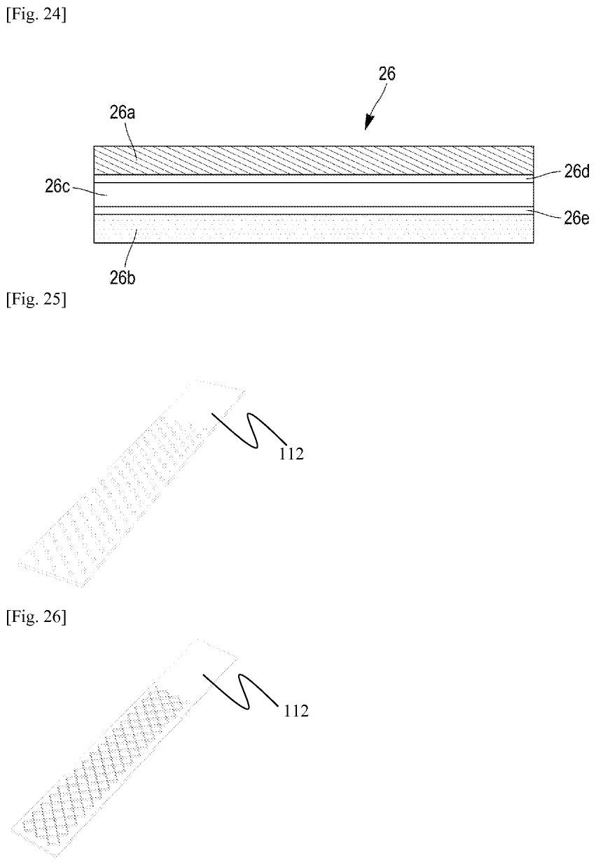

FIG. 22 represents a second example mentioned without limitation of a shoe 200 according to the present disclosure, comprising a sole 220 and a shaft 230. The shaft main material may be selected from among polyolefins, styrenic thermoplastic elastomers, olefinic thermoplastic elastomers, vulcanized thermoplastic elastomers, thermoplastic polyurethanes (TPU), polyamides, an ether-amide block copolymer (PEBA), an ethylene-vinyl acetate (EVA), an ether-ester block copolymer, a styrene-based elastomer, and a polyester; preferably in this specific example a polyolefin, in particular polypropylene.

The shaft 230 comprises a textile portion 240 forming a foot receiving area having an outer face 245, and four strips 250, 251, 252 in an olefinic thermoplastic elastomer secured to the outer face 245 and to the sole 220. A portion of each of the strips is arranged between the sole 220 and the outer face 25 of the textile portion 240.

A strip 250 is arranged over the front edge 205 of the shoe 200, and extends from a lateral side to a medial side of the shoe 200. A strip 251 is arranged over the rear edge 206 of the shoe 200, and extends from a lateral side to a medial side of the shoe 200. A strip 252 is partially arranged along the medial side 207 of the shoe 200, and extends between the front strip 250 and the rear strip 251. A strip, not visible in the photograph of FIG. 4, is partially arranged along the medial side of the shoe 200, and extends between the front strip 250 and the rear strip 251.

Advantageously, the textile portion 240 forming a foot receiving area comprises a textile component which comprises a wire comprising the shaft main material, in particular the shaft main material is a polyolefin or an olefinic thermoplastic elastomer.

Preferably, the four strips, including the strips 250-252, are leatherette-made strips.

Advantageously, each strip comprises a polymer layer based on an olefinic thermoplastic elastomer, the polymer layer being arranged over a textile substrate. Thus, the strips are advantageously compatible with the polymer material(s) of the textile portion 240 and of the sole 220 so that they could be glued by melting, at least partially, their structures to the textile portion 240 and to the sole 220. The strips including the strips 250-252 are glued at the outer face 245 of the textile portion 240 so that the textile substrates are oriented opposite the outer face 245.

The strip, such as one of the strips 250 to 252, may have a configuration different from that of a strip according to the intended functions on the shoe. In general, the strip may be a leatherette-type part having a shape determined according to its final function. In this specific example, the outer faces of the strips 250 to 252 are substantially smooth, but they could comprise one or several relief pattern(s) imprinted onto the polymer layer, for example by calendering.

FIG. 23 represents a third example mentioned without limitation of a shoe 80 according to the present disclosure. The shoe 80 comprises a sole comprising an intermediate sole 21 and an outsole 22, most of the mass of the sole being made of a sole main material, and a shaft 36 most of the mass of which is made of a shaft main material.

The sole main material is a polyester.

The main material of the intermediate sole 21 may be a thermoplastic copolyester of the TPEE (thermoplastic polyether ester elastomer) or TCP-ET (thermoplastic copolyester elastomers) type. These are block copolymers comprising rigid segments of polyester and soft segments of polyether and/or polyester.

The main material of the intermediate sole 21 may be a thermoplastic copolyester, so-called COPE (“Copolyester thermoplastic elastomer”) or TPC (“Thermoplastic Copolyester”), of the TPC-EE (“TPC with soft segments with both ether and ester linkages”), TPC-ES (“TPC with soft segments with ester linkages”) or TPC-ET (“TPC with soft segments with ether linkages”) type.

The intermediate sole 21 may be obtained by injection of a supercritical fluid, as described before.

Advantageously, the intermediate sole 21 is co-molded with the outsole 22.

The outsole 22 may also be glued with the intermediate sole 21.

The intermediate sole 21, provided or not with the outsole 22, may be injected over the shaft. Alternatively, the sole and the shaft 36 may be made separately and assembled later on.

The main material of the outsole 22 may be selected from among TPV-type thermoplastic elastomers.

Thermoplastic vulcanizates (TPV) belong to the class of thermoplastic elastomers, and have, up to some extent, the particularities of thermoplasts and elastomers. In general, these are systems formed of two phases, a soft one, the elastic phase (EPDM) and a hard one, the thermoplastic phase (PP).

Preferably, a thermoplastic vulcanizate is used comprising a thermoplastic phase made of a thermoplastic copolymer, and in particular of TPEE. The soft phase may be made of poly(styrene/butadiene), also called SBR rubber (standing for styrene-butadiene rubber), which is a copolymer of styrene and 1,3-butadiene. The thermoplastic phase may be a thermoplastic phase made of a block copolymer comprising rigid segments of polyester and soft segments of polyether and/or polyester.

Alternatively, the outsole 22 may comprise rubber. In this case, the outsole 22 is advantageously fastened on the intermediate sole 21 using a specific gluing primer which allows disassembling the outsole 22 in preparation for recycling of the shoe.

The shoe 80 may also comprise a first sockliner made of TPEE or of TPC-ET, which can be obtained by injection foaming of a supercritical fluid, as described before.

Preferably, the shaft main material is a polyester too.

Advantageously, the shaft 36 comprises a lace 23 made of polyethylene terephthalate (PET).

The shoe 80 may comprise lacing loops 24 made of polyethylene terephthalate (PET).

The shaft 36 may comprise a lower portion 25 which is a protective layer glued on the shaft. Advantageously, the lower layer 25 is made of a thermoplastic copolyester, and in particular of the TPEE or TPC-ET type.

The shaft 36 may also comprise an upper portion 26 comprising polyethylene terephthalate (PET) and/or a thermoplastic copolyester, for example TPEE.

FIG. 21 shows an embodiment of the upper portion 26. The upper portion 26 may comprise an upper layer 26a made of PET, for example two-dimensionally woven PET mesh, and a lower layer 26b also made of PET, for example a three-dimensionally woven PET mesh. A central layer 26c made of a thermoplastic copolymer, for example of TPEE, and in particular of unwoven TPEE, and surrounded at the top and at the bottom by an adhesive intermediate layer 26d, 26e. An upper intermediate layer 26d is arranged between the central layer 26c and the upper layer 26a, whereas a lower intermediate layer 26e is arranged between the central layer 26c and the lower layer 26b.

At the rear of the shoe 80, a reinforcing ring 27 is arranged between the shaft 36 and the intermediate sole 21, which is an injected rigid insert, the insert being positioned in the mold, and assembled, or not, with the shaft. Advantageously, the ring 27 is made of a thermoplastic copolyester, and in particular of the TPEE or TPC-ET type. The ring 27 may be glued between the shaft 30 and the intermediate sole 21.

The shaft 36 may also comprise an upper reinforcement 51 made of foam improving the accommodation of the hindfoot. The upper reinforcement 51 may be made of PET, and in particular of unwoven PET.

The shaft 36 comprises a hindfoot region 28, a forefoot region 29, a lateral region 31, a medial region 32 and an instep region 33 comprising a tab 34.

Advantageously, the tab 34 is made of PET, and in particular of unwoven PET.

The shaft may comprise a wire made of polyester, and in particular made of TPEE, which confers flexibility on the shoe.

Preferably, the outsole 22 is manufactured at the same time as it is secured to the shaft. In this case, the outsole is injected directly over the shaft, i.e. over the lower portion of the shaft 36, preferably with the previously-described process.

Advantageously, the main material of the shaft 36 is compatible with, or made of the same base thermoplastic material as, the sole main material, so that the outsole adheres to the shaft, preferably without using any external bonding agent.

Alternatively, the shoe 80 may be manufactured according to a Strobel-type conventional mounting. The outsole 22 may be secured to the shaft 36 by gluing. Hence, the outsole 22 and the shaft 36 are manufactured separately, then secured.

The adhesives that could be used to assemble the different portions of the shoe 80, and in particular to assemble the shaft to the sole, may be polyurethane or polyester based adhesive.

The table hereinbelow summarizes mechanical properties measured on examples of polymer mixtures derived from the recycling of shoes obtained by the method according to the present disclosure.

| | Example | Example | Example | Example | Example |
|---|---|---|---|---|---|
| Tests | 1 | 2 | 3 | 4 | 5 |
| Tensile strength (MPa) ISO 37: 2017 | 8.0 | 10.7 | 9 | 9.3 | 9.6 |
| Elongation at beak (%) ISO 37: 2017 | 517 | 617 | 691 | 641 | 538 |
| Hardness (Shore A) ISO 868: 2003 | 80 | 87 | 86 | 85 | 85 |
| Abrasion (mm3) ISO 4649-method A: 2017 | 88 | 48 | 69 | 72 | 58 |
| Density (kg/liter) ISO 2420: 2017 | 0.88 | 0.91 | 0.88 | 0.91 | 0.88 |

The mixture of Example 1 is derived from the recycling of a shoe free of contaminant material within the meaning of the present text. Thus, the shoe recycled to obtain the mixture of Example 1 comprises 50 g of polypropylene (PP), 12 g of polyethylene (PE), 250 g of styrene-ethylene-butadiene-styrene (SEBS), and 25 g of a vulcanized thermoplastic elastomer (TPV), in this specific example EPDM (ethylene-propylene-diene)/PP (polypropylene)).

The shoe recycled to obtain the mixture of Example 2 is identical to the shoe of Example 1 with the difference that the sole of the recycled shoe in this Example 2 comprises thermoplastic polyurethane whose mass fraction is 2%.

The recycled shoe of the mixture of Example 3 is identical to the shoe of Example 2 with the difference that the mass fraction of thermoplastic polyurethane in the shoe is 5%.

The recycled shoe of the mixture of Example 4 is identical to the shoe of Example 2 with the difference that the mass fraction of thermoplastic polyurethane in the shoe is 10%.

The shoe of the mixture of Example 5 is identical to the shoe of Example 1 with the difference that the shoe of Example 5 comprises 2 weight % of thermoplastic polyamide originating from a loop-and-hook attachment system made of polyamide of the recycled shoe.

One could notice that the presence of polyurethane and polyamide, at most at 10 weight % of the shoe, allows improving the yield strength, but also surprisingly the resistance to abrasion. Beyond 10 weight % of polyurethane, a decrease in the resistance to abrasion is observed.

Moreover, the obtained recycled mixtures can perfectly be hot transformed (extrusion-injection or blowing, or by hot pressing, extrusion molding, . . . ) and that being so while preserving final properties enabling numerous new applications thereof.

1-38. (canceled)

39. A method for manufacturing at least one portion of a footwear comprising the following steps:
providing a mold defining an open cavity, a shape of at least one portion of the cavity corresponding to a shape of a sole of the footwear, the cavity being configured to receive, via at least one injection channel opening into the cavity, a mixture comprising a molten material and a supercritical fluid;
placing a rim of an opening of the open cavity in contact with a docking area of a surface of at least one portion of a shaft of the footwear, so that the surface of the at least one portion of the shaft of the footwear ensures closure of the cavity at a level of the contact between the docking area and the rim;
pressurizing the cavity;
injecting the mixture in the cavity;
depressurizing the cavity of the mold, to trigger an expansion of the mixture in the cavity and form the sole in a foamed material resulting from the expansion of the mixture, the at least one portion of the surface of the at least one portion of the shaft being embedded in said foamed material of the sole.

40. The method according to claim 39, further comprising, prior to the step of pressurizing the cavity, the following step:
placing a cap over the mold so as to form with the mold a closed volume comprising the cavity, and a complementary portion of the cavity in said closed volume, the at least one portion of the shaft being located inside said closed volume, the complementary portion and the cavity being located on either side of the closure of the cavity at the level of the contact between the docking area and the rim.

41. The method according to claim 40, further comprising the following steps, implemented before the step of placing the rim of the opening of the open cavity in contact with the docking area of a surface of the at least one portion of a shaft:
providing a support having a shape corresponding to a shape of a foot,
covering, at least partially, an outer surface of the support with the at least one portion of the shaft of the footwear, the at least one portion of the surface of the at least one portion of the shaft covering a portion of the outer surface of the support corresponding to a sole of said foot,
so that after placing the cap over the mold, the closed volume further comprises the support with the at least one portion of the shaft.

42. The method according to claim 39, wherein the cavity is configured to receive the mixture via at least two injection channels opening into the cavity.

43. The method according to claim 39, wherein the mold comprises the at least one injection channel.

44. The method according to claim 41, wherein the support comprises the at least one injection channel.

45. The method according to claim 39, comprising a step of gluing the at least one portion of the surface of the at least one portion of the shaft, the step of gluing being carried out before the injecting step.

46. The method according to claim 39, wherein the at least one portion of the surface of the at least one portion of the shaft comprises hot-melt wires configured to melt down at an injection temperature of the mixture.

47. The method according to claim 39, further comprising the following steps:
providing inserts configured to be positioned in the cavity of the mold;
positioning the inserts in the cavity of the mold.

48. The method according to claim 39, wherein the at least one portion of the surface of the at least one portion of the shaft is at least partially punctured or open.

49. The method according to claim 39, wherein the at least one portion of the surface of the at least one portion of the shaft, is textured or apertured on contact with the docking area.

50. The method according to claim 39, wherein the molten material is an elastomer thermoplastic polymer.

51. The method according to claim 39, wherein the supercritical fluid is nitrogen in a supercritical state or carbonic gas in a supercritical state or a mixture of nitrogen and carbonic gas in a supercritical state.

52. The method according to claim 39, wherein:
most of the shaft in terms of mass being made of a shaft main material, and possibly of one or several shaft auxiliary material(s);
most of the sole in terms of mass being made of a sole main material, and possibly of one or several sole auxiliary material(s), the foamed material, resulting from the expansion of the mixture, comprising said sole main material and said sole auxiliary material(s);
the shaft main material, and possibly the shaft auxiliary material(s), is/are selected from among the following materials: polyolefins, styrenic thermoplastic elastomers, olefinic thermoplastic elastomers, vulcanized thermoplastic elastomers, a thermoplastic polyurethane (TPU), polyamides, an ether-amide block copolymer (PEBA), an ethylene-vinyl acetate (EVA), an ether-ester block copolymer, a styrene-based elastomer, and a polyester, and
the sole main material, and possibly the sole auxiliary material(s), is/are of the same chemical family as the shaft main material, and possibly is/are of the same chemical family as the shaft auxiliary material(s), or in that the sole main material, and possibly the sole auxiliary material(s) is/are chemically compatible with the shaft main material, and possibly with the shaft auxiliary material(s).

53. A footwear obtained by the method according to claim 39.

54. A device for the manufacture of at least one portion of a footwear, the device comprising a mold, defining an open cavity, a shape of at least one portion of the cavity corresponding to a shape of a sole of the footwear, the cavity being configured to receive, via at least one injection channel opening into the cavity, a mixture comprising a molten material and a supercritical fluid, a rim of an opening of the open cavity being configured to be placed in contact with a docking area of a surface of at least one portion of a shaft of the footwear, so that the surface of the at least one portion of the shaft ensures closure of the cavity at the level of the contact between the docking area and the rim, so that said device is thus configured to implement the method according to claim 39.

55. The method according to claim 41, wherein the cavity is configured to receive the mixture via at least two injection channels opening into the cavity.

56. The method according to claim 55, wherein the mold comprises the at least two injection channels.

57. The method according to claim 56, wherein the support comprises the at least two injection channels.

58. The method according to claim 57, comprising a step of gluing the at least one portion of the surface of the at least one portion of the shaft, the step of gluing being carried out before the injecting step.
